(19) United States
(12) Patent Application Publication
(10) Pub. No.: US 2023/0245033 A1
(43) Pub. Date: Aug. 3, 2023

(54) SYSTEM AND METHOD FOR MEASURING AN AGENT ENGAGEMENT INDEX AND ASSOCIATING ACTIONS TO IMPROVE THEREOF

(71) Applicant: NICE LTD., Ra'anana (IL)

(72) Inventors: Mahesh BAIRAGI, Pune (IN); Santosh AWASARE, Pune (IN)

(21) Appl. No.: 17/589,944

(22) Filed: Feb. 1, 2022

(51) Int. Cl. G06Q 10/06; G06Q 10/10; H04M 3/51

(52) U.S. Cl. CPC G06Q 10/06398; G06Q 10/06395; G06Q 10/105; H04M 3/5175; H04M 2201/42; H04M 2203/401; H04M 2203/402

(57) ABSTRACT

A computerized-method for measuring an Agent-Engagement-Index (AEI) and associating actions to improve thereof, is provided herein. The computerized-method may operate an AEI module for an assessment of agents. The AEI module includes: (i) retrieving data from applications to derive agent's related-data and exporting the agent's related-data into data-files; (ii) operating a data-ingest module to store the agent's related-data from the data-files; (iii) operating a transform module to transform the agent's related-data by creating relational-entities and calculating metrics; (iv) operating an analytic-engine to process the relational-entities and the calculated metrics for calculating indicators and an AEI based thereon; (v) determining actions to improve the AEI based on the calculated AEI and the indicators; (vi) storing the determined actions in the data-store of agents to improve the AEI and the indicators; and (vii) upon user's request displaying the indicators and the AEI for each agent and the determined actions for each agent.

### TECHNICAL FIELD

The present disclosure relates to the field of data analysis and more specifically, to measuring an agent engagement index and associating actions to improve thereof, in a contact center.

### BACKGROUND

Organizations constantly measure one or more key performance indicators (KPI)s in their contact center to optimize agents' performance and hence increase their profits. Another metric that is measured to reduce agent attrition and keep the agents productive is agents' engagement and satisfaction.

Commonly, organizations depend on employee surveys to get insights about agent satisfaction and engagement. However, these surveys often suffer from recency bias, reflect perception more than facts and are subjective in nature. Moreover, measuring agent engagement based on satisfaction or engagement surveys is a unidimensional approach and does not consider the following key indicators as well as contributors: (i) organizational action and investments, such as agent preference adherence, coaching need identification and coaching effectiveness improvement and (ii) agent actions, such as agent performance metrics and desktop analytics of productive time.

Existing solutions for measuring agent satisfaction and engagement are based on employee feedback through surveys and similar means and more often than not suffer from subjectivity and perceptions that are inherently associated with feedback systems. Additionally, existing solutions do not consider facts pertaining to agent and organizational actions which are both indicators and contributors to agent engagement.

Accordingly, there is a need for a technical solution for measuring an Agent Engagement Index (AEI) based on agents parameters and organization actions and associating actions to improve thereof.

### SUMMARY

There is thus provided, in accordance with some embodiments of the present disclosure, a computerized-method for measuring an Agent Engagement Index (AEI) and associating actions to improve thereof.

Furthermore, in accordance with some embodiments of the present disclosure, in a computerized system that includes one or more processors, a data store of agents and a data store of processing management; a memory to store the data store, and a Performance Management (PM) application, the one or more processors may operate an Agent Engagement Index (AEI) module for an assessment of each agent in the data store of agents.

Furthermore, in accordance with some embodiments of the present disclosure, the AEI module may include: (i) retrieving data during a preconfigured period from one or more applications to derive agent's related data and exporting the agent's related data into data files; (ii) operating a data-ingest module to store the agent's related data from the data files into the data store of processing management; (iii) operating a transform module to transform the agent's related data by creating relational entities and calculating metrics; (iv) operating an analytic engine to process the relational entities and the calculated metrics for calculating one or more indicators and an AEI based thereon; (v) determining one or more actions to improve the AEI based on the calculated AEI and the one or more indicators; (vi) storing the determined one or more actions to improve the AEI, and the one or more indicators; and (vii) upon user's request via a User Interface (UI) that is associated with the PM application displaying the one or more indicators and the AEI for each agent and the determined one or more actions for each agent.

Furthermore, in accordance with some embodiments of the present disclosure, the one or more applications may be in-house applications or third-party applications, which may be integrated into the system.

Furthermore, in accordance with some embodiments of the present disclosure, the one or more indicators may be selected from at least two of: (i) agent preference adherence; (ii) performance metrics; (iii) coaching need; (iv) coaching effectiveness; and (v) agent satisfaction.

Furthermore, in accordance with some embodiments of the present disclosure, the agent preference adherence indicator may be calculated based on formula I:

[(Σᵢ₌₁ⁿ Weightageᵢ*Adherence_Valueᵢ)/((Σᵢ₌₁ⁿ Weightageᵢ)*10)]ₜ (I)

whereby:
i denotes a current iteration over a list of preferences,
n denotes a size of the list of preferences,
Weightageᵢ is a weightage associated with an i^{th} preference in the list of preferences,
Adherence_Valueᵢ is an adherence metric value for i^{th} preference, and
t is a duration of an assessment.

Furthermore, in accordance with some embodiments of the present disclosure, the performance metrics indicator may be calculated based on formula II:

[(Σᵢ₌₁ⁿ Weightageᵢ*Metrics_Percentageᵢ)/((Σᵢ₌₁ⁿ Weightageᵢ)*10)]ₜ (II)

whereby:
i denotes a current iteration over a list of the calculated metrics,
n denotes a size of the list of the calculated metrics,
Weightageᵢ is a weightage associated with an i^{th} metric in the list of the calculated metrics,
Metrics_ Percentageᵢ is a metric percentage value for the i^{th} metric, and
t is a duration of an assessment.

Furthermore, in accordance with some embodiments of the present disclosure, the coaching need indicator may be calculated based on formula III:

[10−((Σᵢ₌₁ⁿ MetricWeightageᵢ*(MetricValueᵢ<X:1:0))/10)]ₜ (III)

whereby:
i denotes current iteration over a list of the calculated metrics,
n denotes a size of the list of the calculated metrics,
MetricWeightageᵢ is a weightage associated with an i^{th} metric,
MetricValueᵢ is a metric percentage value for the i^{th} metric,
X is a threshold value to identify a low performance,
(MetricValueᵢ<X:1:0) is if (MetricValue<X) is true then 1 else 0, and
t is a duration of an assessment.

Furthermore, in accordance with some embodiments of the present disclosure, the coaching effectiveness indicator may be calculated based on formula IV:

[(Σᵢ₌₁ⁿ % Improvement in Coaching Metricsᵢ)/(n*10)]ₜ (IV)

whereby:
i denotes a current iteration over the list of the calculated metrics,
n denotes a size of the list of the calculated metrics,
% Improvement in Coaching Metricsᵢ is an improvement seen after coaching was done, and
t is a duration of an assessment.

Furthermore, in accordance with some embodiments of the present disclosure, the agent satisfaction indicator may be calculated based on formula V:

[(Σᵢ₌₁ⁿ MeasureScoreᵢ)/(n*10)]ₜ (V)

whereby:
i denotes current iteration over a list of measures,
n denotes a size of the list of measures,
MeasureScoreᵢ is a score value of an i^{th} measure, and
t is a duration of an assessment.

Furthermore, in accordance with some embodiments of the present disclosure, the AEI may be calculated based on formula VI:

$$If {( Coaching Done ) [ \frac{{\sum }_{i = 1}^{n} ( Weightage\_Coaching {\_done}_{i} * {indexValue}_{i} )}{{\sum }_{i = 1}^{5} Weightage\_Coaching {\_done}_{i}} ]}_{t} \qquad ( VI )$$

$${Else [ \frac{{\sum }_{i = 1}^{n} ( Weightage\_Coaching \_not {\_done}_{i} * {indexValue}_{i} )}{{\sum }_{i = 1}^{5} Weightage\_Coaching \_not {\_done}_{i}} ]}_{t}$$

whereby:
‘Coaching Done’ is a binary indicator for an executed coaching where ‘1’—indicates that coaching has been done and ‘0’ indicates that coaching has not been done,
n is a number of indicators,
i denotes a current iteration over the indicators,
Weightage_Coaching_doneᵢ is a weightage associated with an i^{th} indicator, indicator when coaching was executed for the agent,
indexValueᵢ is a calculated indicator value for the indicator,
Weightage_Coaching_not_doneᵢ is a weightage associated with an i^{th} indicator when coaching was not executed for the agent, and
t is a duration of an assessment.

Furthermore, in accordance with some embodiments of the present disclosure, the determined one or more actions may be selected from at least one of: (a) targeted coaching plan; (b) agent preference management (c) attrition management; and (d) improved workforce management.

Furthermore, in accordance with some embodiments of the present disclosure, the agent's related data may include at least one on (i) agent key preferences; (ii) adherence metric values; and (iii) performance metric values.

Furthermore, in accordance with some embodiments of the present disclosure, the agent preference management action may be operated by: for each agent preference adherence indicator when the agent preference adherence indicator is lower than a first-preconfigured threshold selecting ‘n’ preferences which are the highest based on their weightage from preferences that the adherence value is less than a second-preconfigured threshold and when the agent preference adherence indicator is higher than the first-preconfigured threshold selecting ‘n’ preferences which are the highest based on their weightage.

Furthermore, in accordance with some embodiments of the present disclosure, the selected ‘n’ preferences may be sent to the PM application to be presented via the UI.

Furthermore, in accordance with some embodiments of the present disclosure, the targeted coaching plan action may be operated by: for each agent coaching need indicator, (a) when the coaching need indicator is greater than a first-preconfigured threshold or (b) when coaching has been done for the agent and coaching effectiveness is greater than or equal ‘0’ or (c) when coaching hasn't been done, (i) selecting from the calculated metrics of the agent which are below a second-preconfigured threshold; identifying from the selected calculated metrics of the given agent metrics against which coaching has been done to select metrics where the difference between metric before coaching and after coaching is greater than a third-preconfigured threshold; (ii) identifying from the selected calculated metrics of the given agent metrics against which coaching has not been done to select metrics which are below the threshold; (iii) selecting ‘n’ metrics from the identified metrics which are highest based on their associated weightage; and (iv) sending the selected ‘n’ metrics to a coaching management application to be presented via a UI associated therewith.

Furthermore, in accordance with some embodiments of the present disclosure, the improved workforce management action may be operated for each agent performance metrics indicator by, checking if the agent performance metrics indicator is less than a preconfigured threshold to operate: (i) a targeted coaching plan management; and (ii) an agent preference management; and then checking if the agent performance metrics indicator is less than the preconfigured threshold to send the calculated list of metrics to a Workforce Management (WFM) application.

Furthermore, in accordance with some embodiments of the present disclosure, the attrition management may be operated for each AEI by checking if the AEI value is less than a threshold to operate an improved workforce management, and then checking if the AEI value is less than the threshold to select ‘n’ lowest indicators; and sending the ‘n’ lowest indicators and an attrition notification to a Human Resources (HR) application to be displayed via a display unit. The notification may lead HR to take an appropriate action in order to prevent attrition.

There is further provided, in accordance with some embodiments of the present disclosure, a computerized-system for measuring an Agent Engagement Index (AEI) and associating actions to improve thereof.

Furthermore, in accordance with some embodiments of the present disclosure, the computerized-system may include: one or more processors; a data store of agents and a data store of processing management; a memory to store the data store; and a Performance Management (PM) application, the one or more processors may operate an Agent Engagement Index (AEI) module for an assessment of each agent in the data store of agents.

Furthermore, in accordance with some embodiments of the present disclosure, the AEI module may include: (i) retrieving data during a preconfigured period from one or more applications to derive agent's related data and exporting the agent's related data into data files; (ii) operating a data-ingest module to store the agent's related data from the data files into the data store of processing management; (iii) operating a transform module to transform the agent's related data by creating relational entities and calculating metrics; (iv) operating an analytic engine to process the relational entities and the calculated metrics for calculating one or more indicators and an AEI based thereon; (v) determining one or more actions to improve the AEI based on the calculated AEI and the one or more indicators; (vi) storing the determined one or more actions to improve the AEI, and the one or more indicators; and (vii) upon user's request via a User Interface (UI) that is associated with the PM application displaying the one or more indicators and the AEI for each agent and the determined one or more actions for each agent.

### BRIEF DESCRIPTION OF THE DRAWINGS

FIG. 1 schematically illustrates a high-level diagram of a system for measuring an Agent Engagement Index (AEI) and associating actions to improve thereof, in accordance with some embodiments of the present disclosure;

FIGS. 2A-2B are a high-level workflow of an Agent Engagement Index (AEI) module, in accordance with some embodiments of the present disclosure;

FIG. 3 is a high-level diagram of an example of a system for measuring an AEI and associating actions to improve thereof, in accordance with some embodiments of the present disclosure;

FIG. 4 illustrates an example of an indication of AEI ranges, in accordance with some embodiments of the present disclosure;

FIG. 5 is a high-level workflow of an agent preference management operation, in accordance with some embodiments of the present disclosure;

FIG. 6A-6B are a high-level workflow of a targeted coaching plan operation, in accordance with some embodiments of the present disclosure;

FIG. 7 is a high-level workflow of an improved workforce management operation, in accordance with some embodiments of the present disclosure;

FIG. 8 is a high-level workflow of an attrition management operation, in accordance with some embodiments of the present disclosure;

FIGS. 9A-9C are an example of a calculation of agent preference adherence indicator given preferences and associated weights and preferences values received against each agent from the Performance Management (PM) application in accordance with some embodiments of the present disclosure;

FIGS. 10A-10D are an example of performance metrics indicator calculation given two months of calculated metrics for agents and the associated weight for each performance metric, in accordance with some embodiments of the present disclosure;

FIGS. 11A-11B are an example of a calculation of a coaching need indicator given the associated weight and threshold for each performance metric, in accordance with some embodiments of the present disclosure;

FIG. 12A-12C are an example of a calculation of a coaching effective indicator given the associated weight for each performance metric and the improvement percentage for each performance metric for each agent, in accordance with some embodiments of the present disclosure;

FIG. 13A-13B are an example of a calculation of agent satisfaction indicator over a given list of measures, in accordance with some embodiments of the present disclosure;

FIGS. 14A-14C are an example of a calculation of Agent Engagement Index (AEI), in accordance with some embodiments of the present disclosure;

FIGS. 15A-15D are illustration examples of User Interface (UI) of agents engagement reports and actions, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

During these times of change, due to Covid-19 pandemic, many organizations are transitioning their contact center to work from home and setting up a foundation for remote work to agents. This transition may lead managers in the contact center to face various issues related to managing a remote workforce, e.g., to ensure employees satisfaction and engagement.

Employees engagement is currently measured merely by agents' feedback, which may not reflect objective parameters. Moreover, employees engagement has to be an effort of both the organization and the agent alike, and concrete actionable insights which are now missing, should be provided. Additionally, current solutions for employees retention are focused on rewards and overlook each agent's preferences and historical results, which are recorded to maintain performance metrics.

Accordingly, there is a need for a technical solution for suggesting organizational actions and investments, such as coaching and preference adherence management, based on considered agent performance metrics, agent preferences and needs. There is a need for method and system for measuring an Agent Engagement Index (AEI) and associating actions to improve thereof

The term “preference adherence” as used herein refers to agent preferences, such as which shill agent prefers to work in, whether agent needs a mentor, choice to work-from-home, technologies, peer coaching, no enforcement of overtime, language and accent of choice.

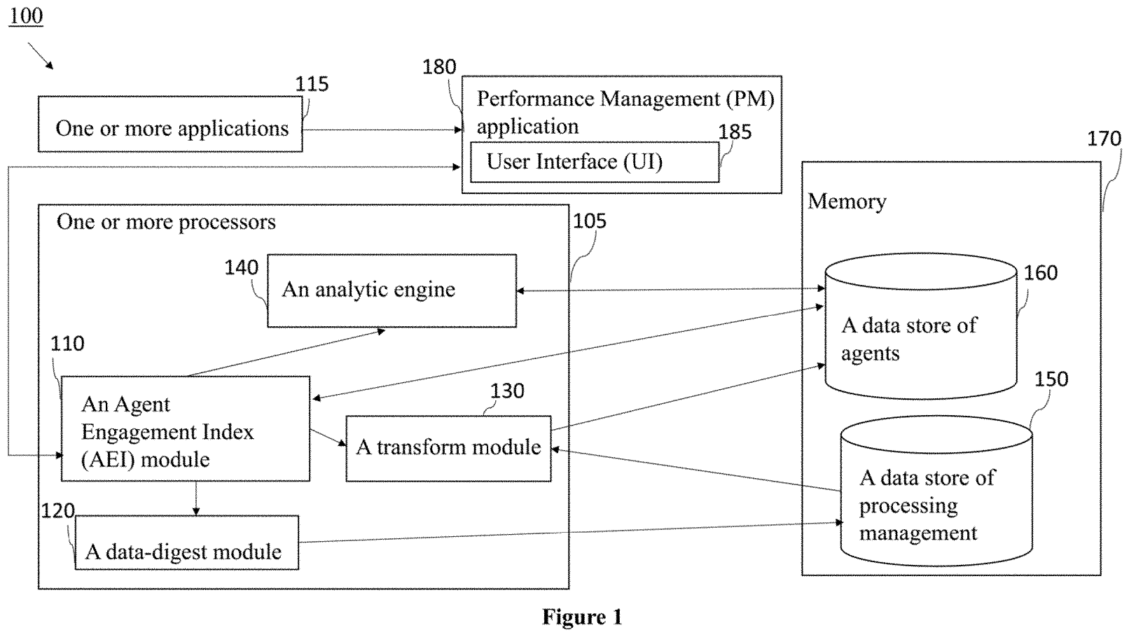

FIG. 1 schematically illustrates a high-level diagram of a system 100 for measuring an Agent Engagement Index (AEI) and associating actions to improve thereof, in accordance with some embodiments of the present disclosure.

According to some embodiments of the present disclosure, a computerized system, such as computerized-system 100, may consider data originating from agent preferences, agent performance and organizational actions. The system 100 may calculate several indicators that have an impact on Agent Engagement Index (AEI) and may calculate the AEI based on these indicators.

According to some embodiments of the present disclosure, based on the calculated indicators, system 100 may suggest one or more actions that may positively improve the indicators and thus improve the AEI and associated benefits, thus implementing the measurement and improvement of the agent engagement.

According to some embodiments of the present disclosure, system 100 may include one or more processors 105, a data store of agents 160 and a data store of processing management 150; a memory 170 to store the data stores, and a Performance Management (PM) application 180. The one or more processors may operate a module, such as Agent Engagement Index (AEI) module 110 and such as AEI module 200 in FIG. 200 for an assessment of each agent in the data store of agents 160.

According to some embodiments of the present disclosure, the AEI module 110 may include: (i) operating the PM application 180 to retrieve data during a preconfigured period, e.g., the duration of the assessment, from one or more applications 115 to derive agent's related data and exporting the agent's related data into data files; (ii) operating a module, such as data-ingest module 120 to store the agent's related data from the data files into a data store, such as the data store of processing management 150; (iii) operating a module, such as transform module 130 to transform the agent's related data by creating relational entities and calculating metrics; and (iv) operating an analytic engine 140 to process the relational entities and the calculated metrics for calculating one or more indicators and an AEI based thereon to be stored in the data store of agents 160.

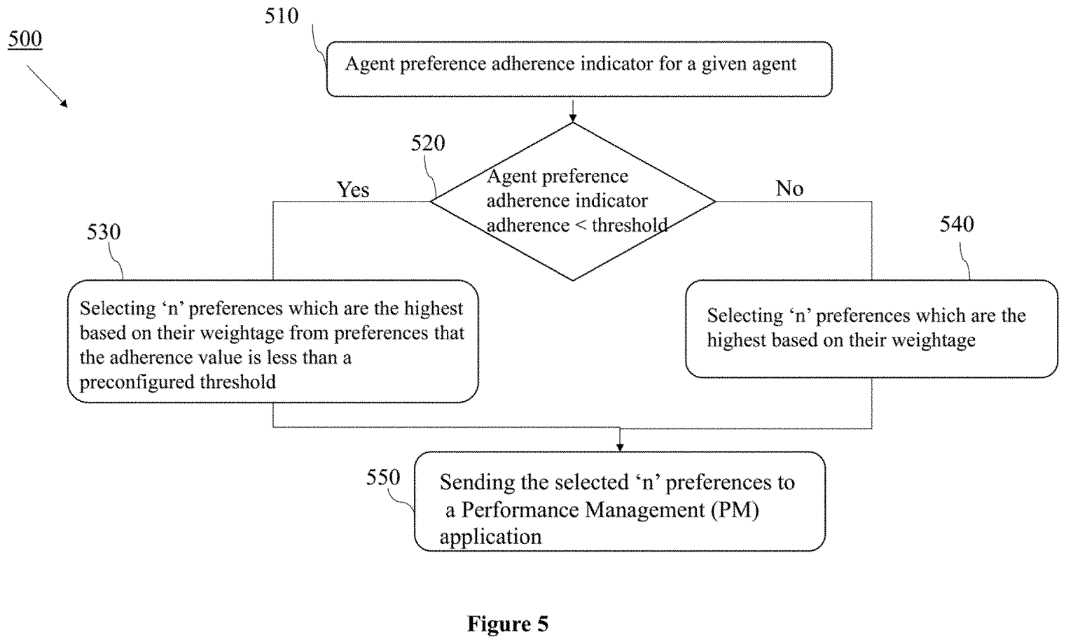

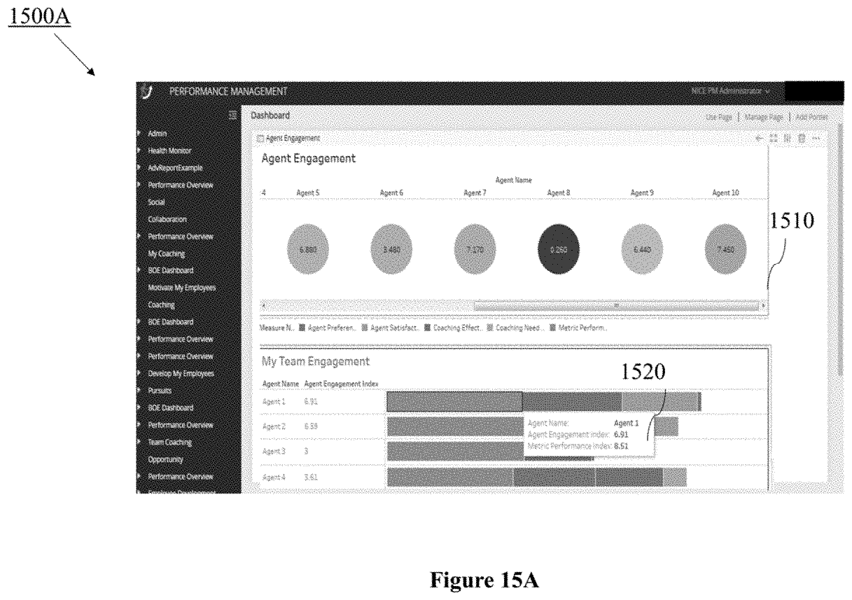

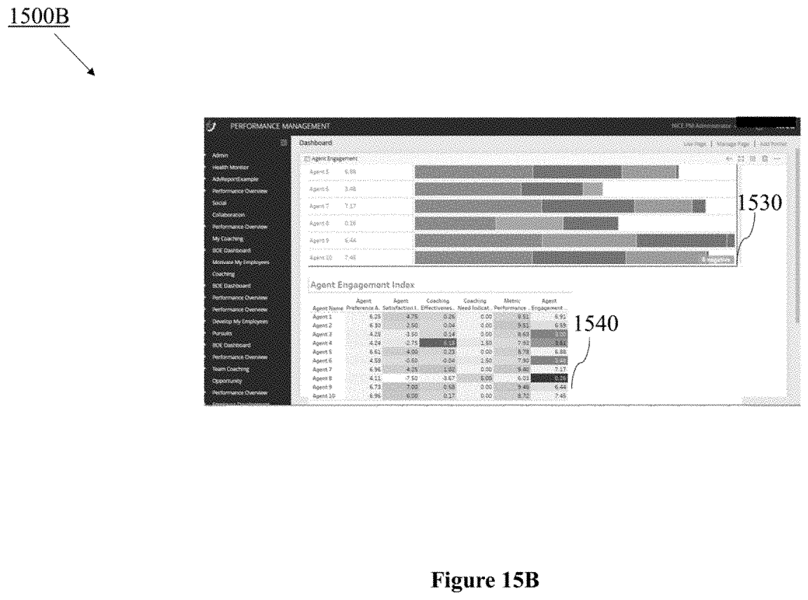

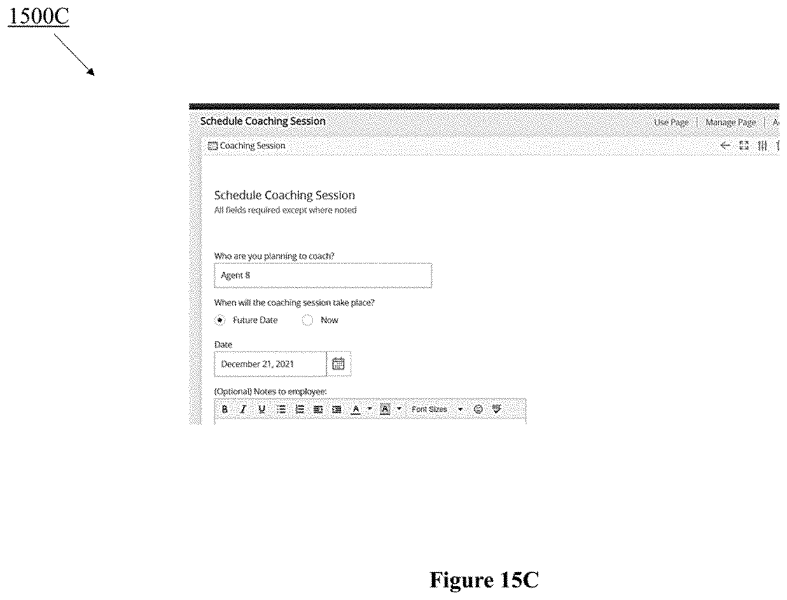

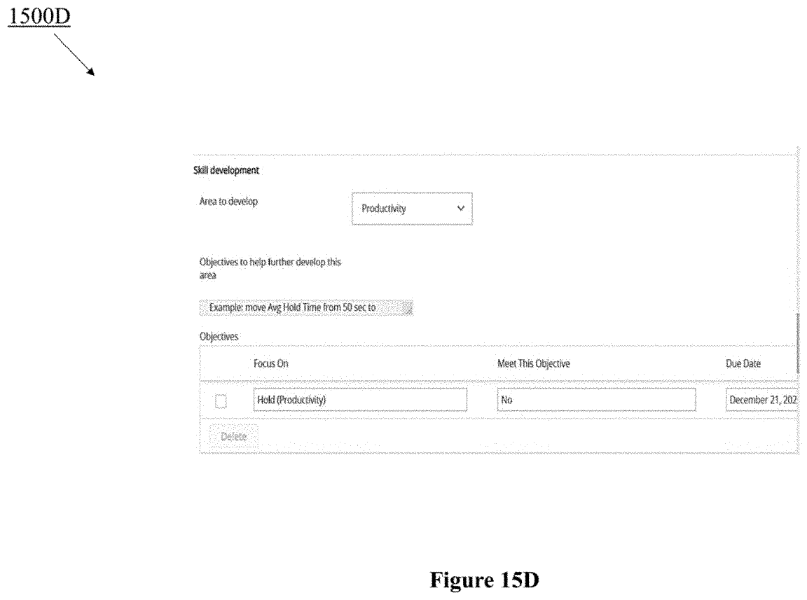

According to some embodiments of the present disclosure, the AEI module 110 may further include: (v) determining one or more actions to improve the AEI based on the calculated AEI and the one or more indicators, as shown in FIGS. 5-8 and described in the related paragraphs; (vi) storing the determined one or more actions in the data store of agents to improve the AEI and the one or more indicators; and (vii) upon user's request that may be operated via a User Interface (UI) 185 that is associated with the PM application 180, displaying the one or more indicators and the AEI for each agent and the determined one or more actions for each agent, for example, as shown in FIGS. 15A-15B.

According to some embodiments of the present disclosure, the agent's related data may include at least one of: (i) agent key preferences; (ii) adherence metric values; and (iii) performance metric values.

According to some embodiments of the present disclosure, the one or more applications 115 may be in-house applications, such as Workforce Management (WFM), Real-Time Availability Monitor (RTAM) or Desktop Analytics of productive time or third-party applications, such as employee satisfaction survey, Automated Call Distribution (ACD) and the like, which may be integrated into the system 100.

According to some embodiments of the present disclosure, the one or more indicators which may be calculated by the analytic engine 140, may be selected from at least two of: (i) agent preference adherence; (ii) performance metrics; (iii) coaching need; (iv) coaching effectiveness; and (v) agent satisfaction.

According to some embodiments of the present disclosure, the agent preference adherence indicator may be calculated based on formula I:

[(Σᵢ₌₁ⁿ Weightageᵢ*Adherence_Valueᵢ)/((Σᵢ₌₁ⁿ Weightageᵢ)*10)]ₜ (I)

whereby:
i denotes a current iteration over a list of preferences,
n denotes a size of the list of preferences,
Weightageᵢ is a weightage associated with an i^{th} preference in the list of preferences,
Adherence_Valueᵢ is an adherence metric value for i^{th} preference, and
t is a duration of an assessment.

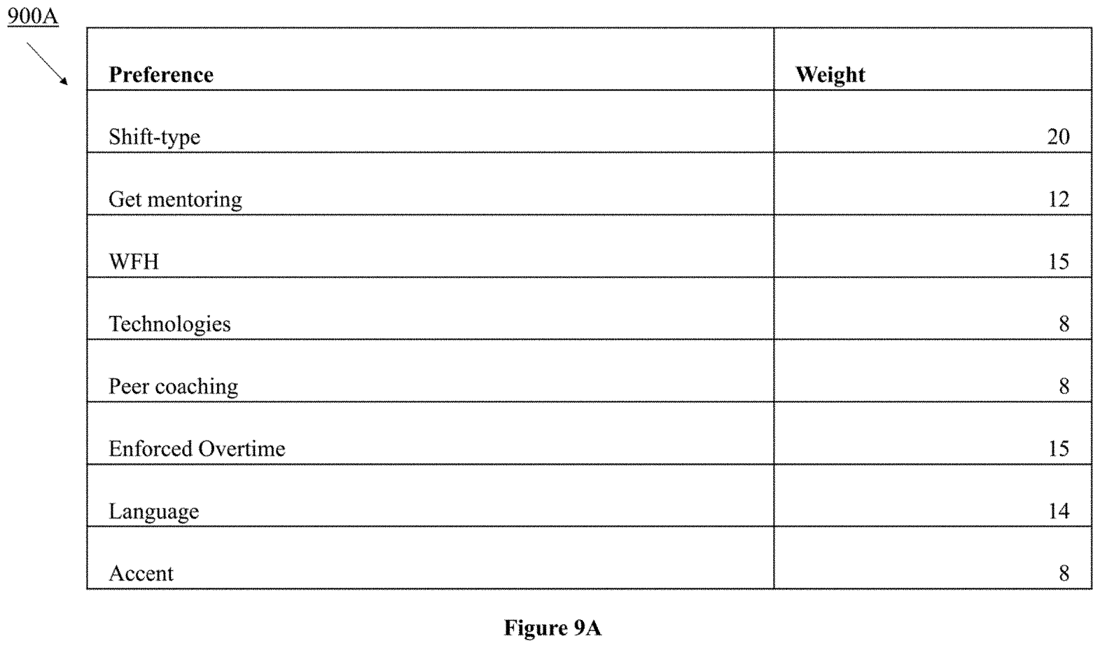

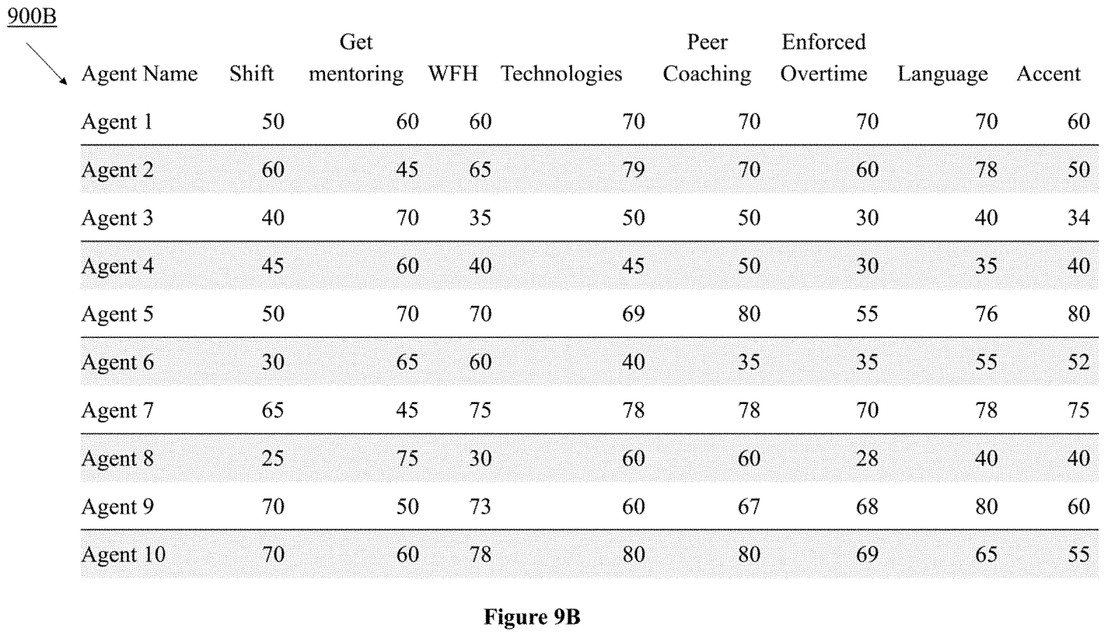

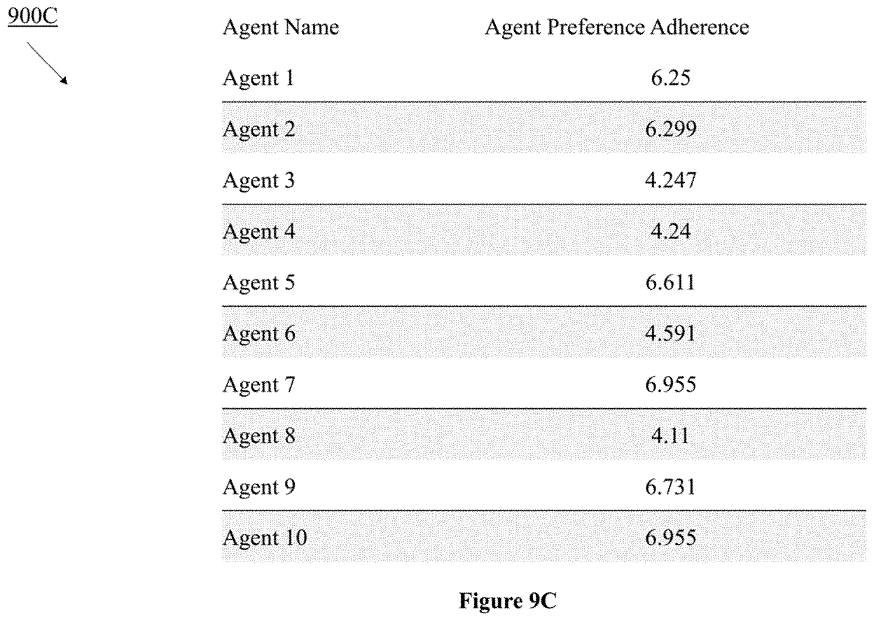

According to some embodiments of the present disclosure, the list of preferences may include agent preferences, for example, a list as shown in FIG. 9A, which includes shift-type, get mentoring, work-from-home, technologies, peer coaching, enforced overtime, language, accent and the like are maintained.

According to some embodiments of the present disclosure, the performance metrics indicator may be calculated based on formula II:

[(Σᵢ₌₁ⁿ Weightageᵢ*Metrics_Percentageᵢ)/((Σᵢ₌₁ⁿ Weightageᵢ)*10)]ₜ (II)

whereby:
i denotes a current iteration over a list of the calculated metrics,
n denotes a size of the list of the calculated metrics,
Weightageᵢ is a weightage associated with an i^{th} metric in the list of the calculated metrics,
Metrics_Percentageᵢ is a metric percentage value for the i^{th} metric, and
t is a duration of an assessment.

According to some embodiments of the present disclosure, the coaching need indicator may be calculated based on formula III:

[10−((Σᵢ₌₁ⁿ MetricWeightageᵢ*(MetricValueᵢ<X:1:0))/10)]ₜ (III)

whereby:
i denotes current iteration over a list of the calculated metrics,
n denotes a size of the list of the calculates i^{th} metrics,
MetricWeightageᵢ is a weightage associated with an i^{th} metric,
MetricValueᵢ is a metric percentage value for the metric,
X is a threshold value to identify a low performance,
(MetricValueᵢ<X:1:0) is if (MetricValue<X) is true then 1 else 0, and
t is a duration of an assessment.

According to some embodiments of the present disclosure, the coaching effectiveness indicator may be calculated based on formula IV:

[(Σᵢ₌₁ⁿ % Improvement in Coaching Metricsᵢ)/(n*10)]ₜ (IV)

whereby
i denotes a current iteration over the list of the calculated metrics,
n denotes a size of the list of the calculated metrics,
% Improvement in Coaching Metrics; is an improvement seen after coaching was done, and
t is a duration of an assessment.

According to some embodiments of the present disclosure, the agent satisfaction indicator may be calculated based on formula V:

[(Σᵢ₌₁ⁿ MeasureScoreᵢ)/(n*10)]ₜ (V)

whereby:
i denotes current iteration over a list of measures,
n denotes a size of the list of measures,
MeasureScoreᵢ is a score value of an i^{th} measure, and
t is a duration of an assessment.

According to some embodiments of the present disclosure, the AEI may be calculated based on formula VI:

$$If {( Coaching Done ) [ \frac{{\sum }_{i = 1}^{n} ( Weightage\_Coaching {\_done}_{i} * {indexValue}_{i} )}{{\sum }_{i = 1}^{5} Weightage\_Coaching {\_done}_{i}} ]}_{t} \qquad ( VI )$$

$${Else [ \frac{{\sum }_{i = 1}^{n} ( Weightage\_Coaching \_not {\_done}_{i} * {indexValue}_{i} )}{{\sum }_{i = 1}^{5} Weightage\_Coaching \_not {\_done}_{i}} ]}_{t}$$

whereby:
‘Coaching Done’ is a binary indicator for an executed coaching where ‘1’ indicates that coaching has been done and ‘0’ indicates that coaching has not been done,
n is a number of indicators,
i denotes a current iteration over the indicators,
Weightage_Coaching_doneᵢ is a weightage associated with an i^{th} indicator when coaching was executed for the agent,
indexValueᵢ is a calculated indicator value for the i^{th} indicator,
Weightage_Coaching_not_doneᵢ is a weightage associated with an i^{th} indicator when coaching was not executed for the agent, and
t is a duration of an assessment.

According to some embodiments of the present disclosure, the determined one or more actions may be selected from at least one of: (a) targeted coaching plan; (b) agent preference management (c) attrition management; and (d) improved workforce management.

According to some embodiments of the present disclosure, the agent preference management may be operated by: for each agent preference adherence indicator when the agent preference adherence indicator is lower than a first-preconfigured threshold then selecting ‘n’ preferences which are the highest based on their weightage from preferences that the adherence value is less than a second-preconfigured threshold and when the agent preference adherence indicator is higher than the first-preconfigured threshold, selecting ‘n’ preferences which are the highest based on their weightage, for example, as shown in FIG. 5.

According to some embodiments of the present disclosure, the AEI module 110 may further include sending the selected ‘n’ preferences to the PM application 180 to be presented via the UI 185.

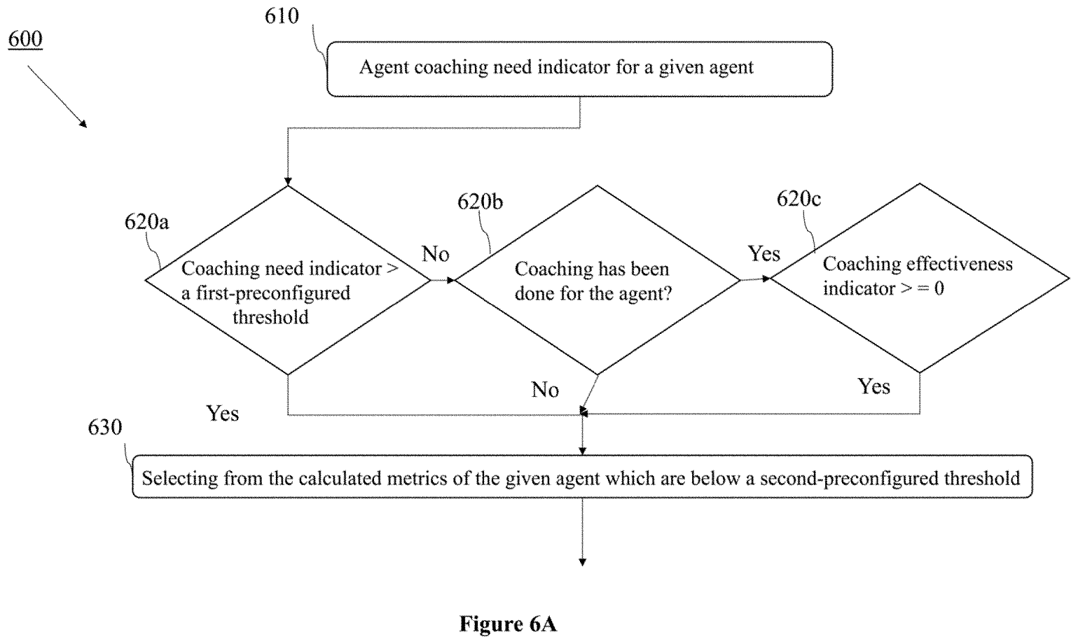

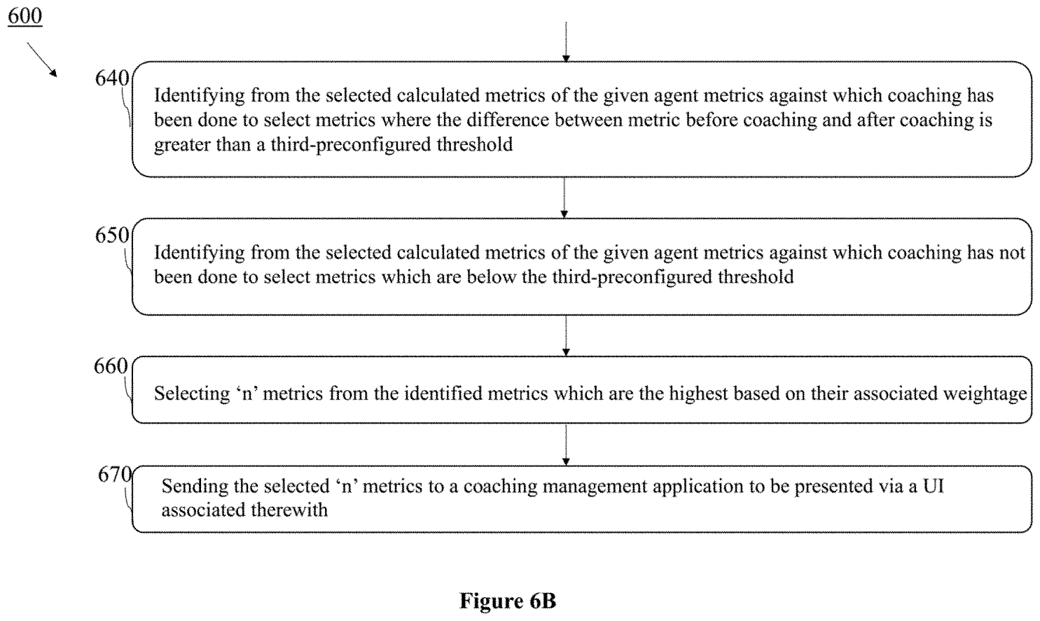

According to some embodiments of the present disclosure, the targeted coaching plan may be operated by: for each agent coaching need indicator, when the coaching need indicator is greater than a first-preconfigured threshold or when coaching has been done for the agent and coaching effectiveness is greater than or equal ‘0’ or when coaching hasn't been done, (i) selecting from the calculated metrics of the agent which are below a second-preconfigured threshold; (ii) identifying from the selected calculated metrics of the given agent metrics against which coaching has been done to select metrics where the difference between metric before coaching and after coaching is greater than a third-preconfigured threshold; (iii) identifying from the selected calculated metrics of the given agent metrics against which coaching has not been done to select metrics which are below the threshold; (iv) selecting ‘n’ metrics from the identified metrics which are highest based on their associated weightage; and (v) sending the selected ‘n’ metrics to a coaching management application to be presented via a UI associated therewith. For example, as shown in FIG. 6.

According to some embodiments of the present disclosure, the improved workforce management may be operated for each agent performance metrics indicator, by checking if the agent performance metrics indicator is less than a preconfigured threshold to operate: (i) a targeted coaching plan management; and (ii) an agent preference management; and then checking if the agent performance metrics indicator is less than the preconfigured threshold to send the calculated list of metrics to a PM application 180.

According to some embodiments of the present disclosure, the attrition management may be operated for each AEI by checking if the AEI is less than a threshold to operate an improved workforce management, and then checking if the AEI is less than the threshold to select ‘n’ lowest indicators; and sending the ‘n’ lowest indicators and an attrition notification to a Human Resources (HR) application. The attrition notification may lead HR to take an appropriate action in order to prevent attrition.

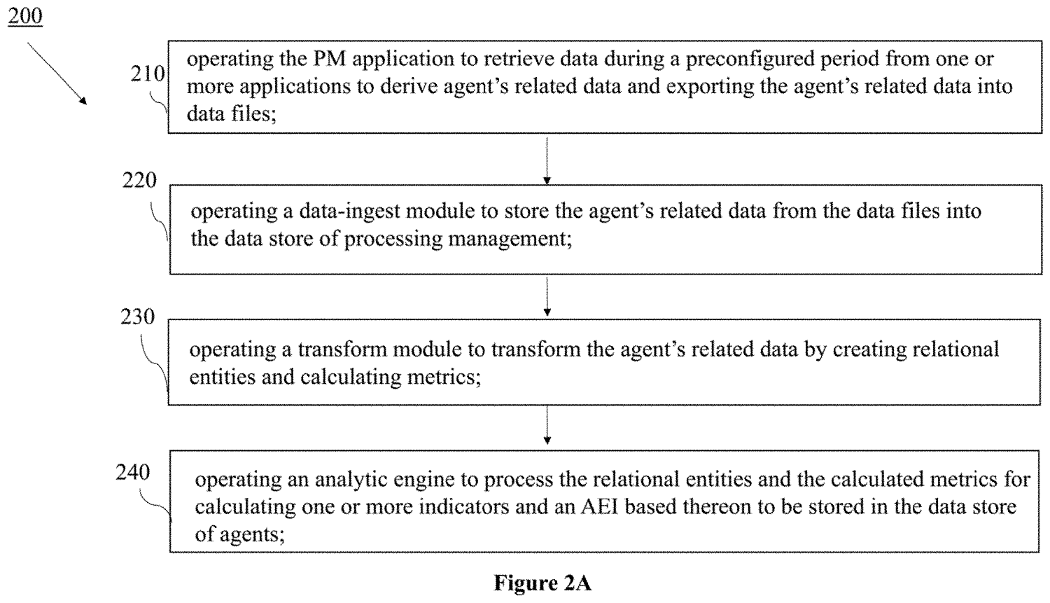

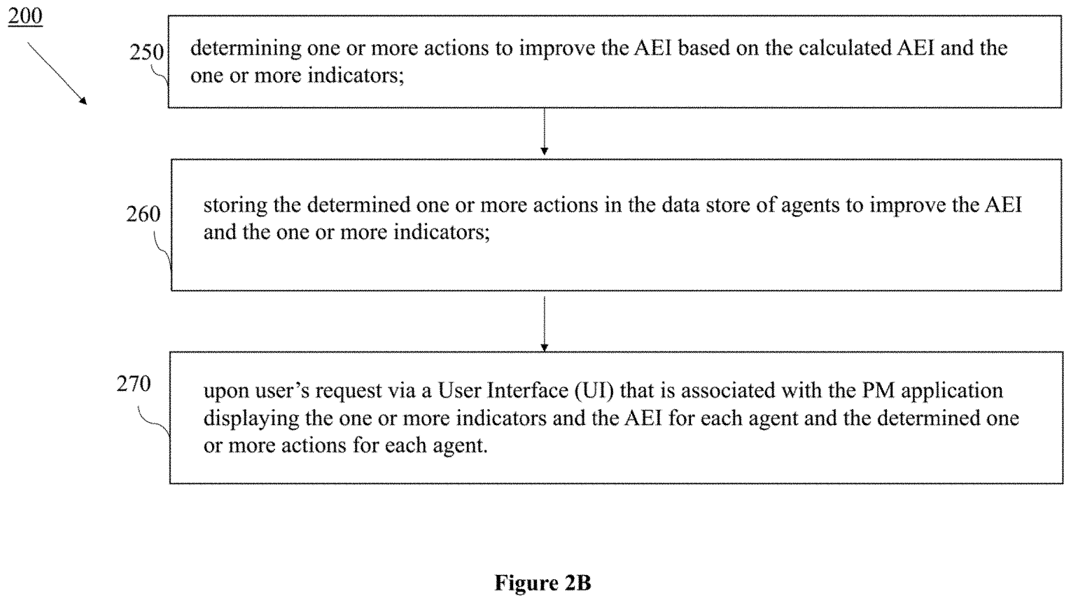

FIGS. 2A-2B are a high-level workflow of an Agent Engagement Index (AEI) module 200, in accordance with some embodiments of the present disclosure.

According to some embodiments of the present disclosure, operation 210 may comprise, operating the PM application to retrieve data during a preconfigured period from one or more applications to derive agent's related data and exporting the agent's related data into data files.

According to some embodiments of the present disclosure, operation 220 may comprise operating a data-ingest module to store the agent's related data from the data files into the data store of processing management.

According to some embodiments of the present disclosure, operation 230 may comprise, operating a transform module to transform the agent's related data by creating relational entities and calculating metrics.

According to some embodiments of the present disclosure, operation 240 may comprise, operating an analytic engine to process the relational entities and the calculated metrics for calculating one or more indicators and an AEI based thereon to be stored in the data store of agents.

According to some embodiments of the present disclosure, operation 250 may comprise, determining one or more actions to improve the AEI based on the calculated AEI and the one or more indicators.

According to some embodiments of the present disclosure, operation 260 may comprise, storing the determined one or more actions in the data store of agents to improve the AEI and the one or more indicators.

According to some embodiments of the present disclosure, operation 270 may comprise, upon user's request via a User Interface (UI) that is associated with the PM application, displaying the one or more indicators and the AEI for each agent and the determined one or more actions for each agent.

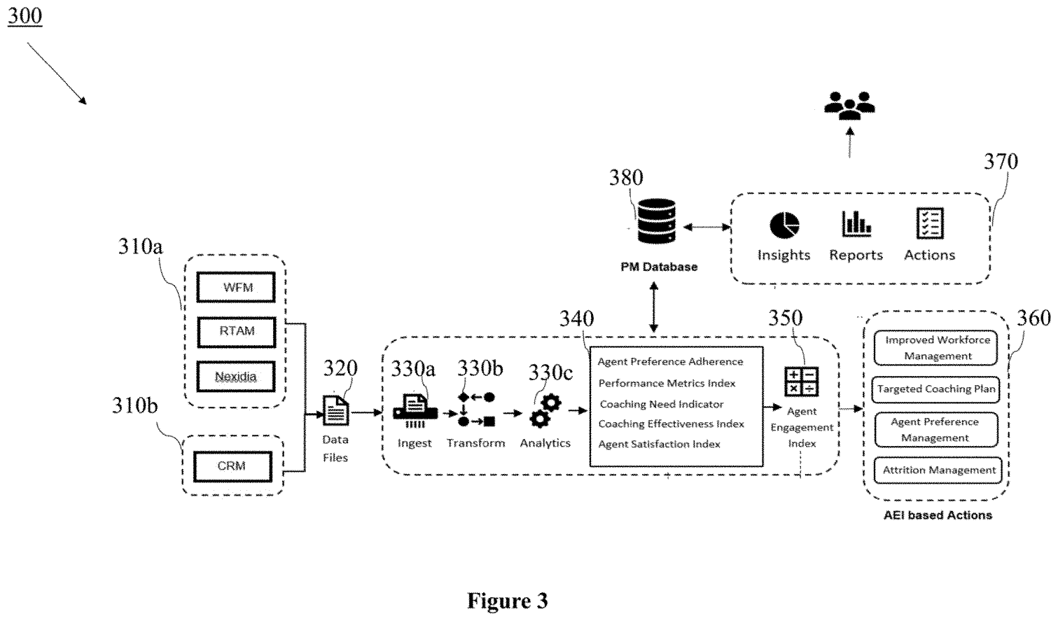

FIG. 3 is a high-level diagram of an example of a system 300 for measuring an AEI and associating actions to improve thereof, in accordance with some embodiments of the present disclosure.

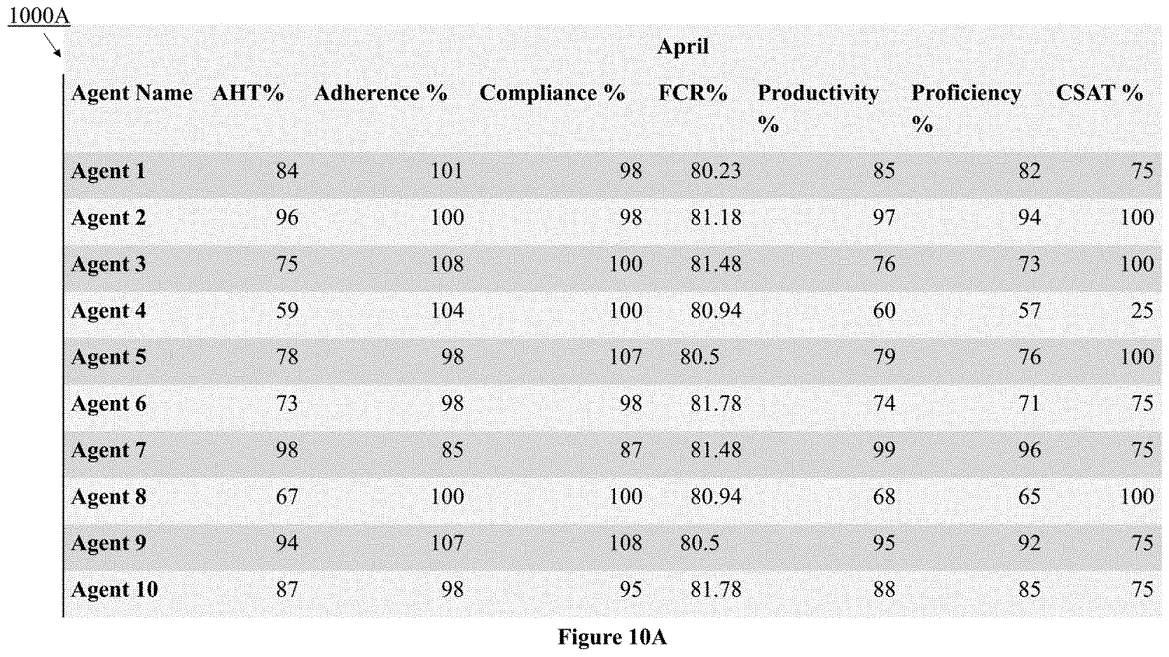

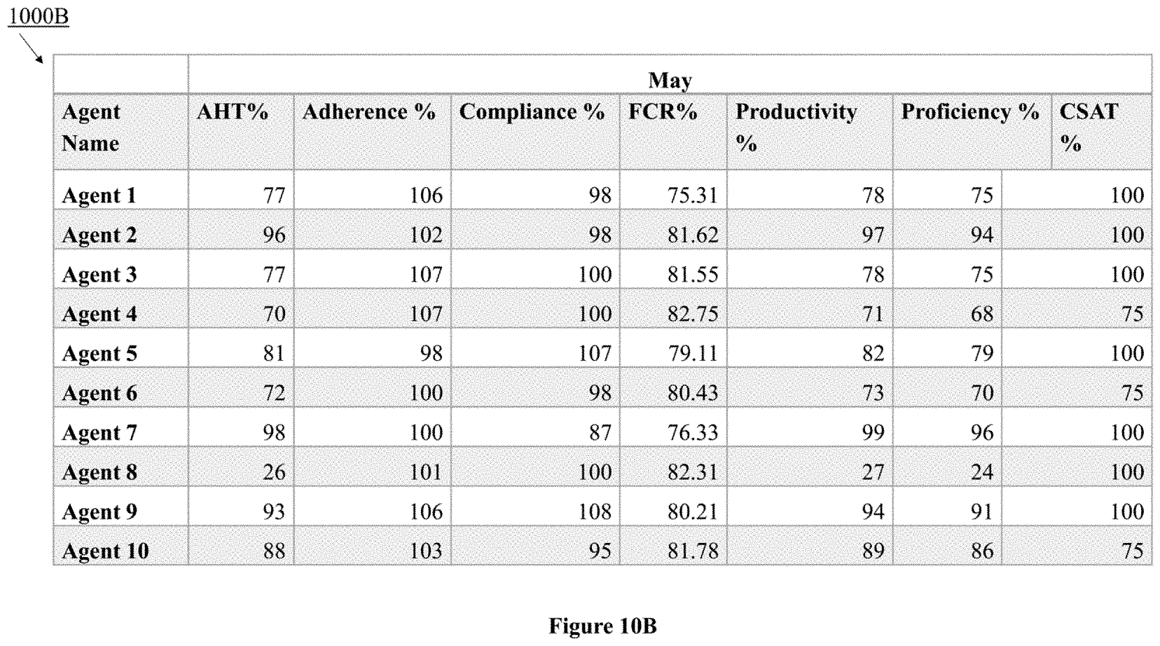

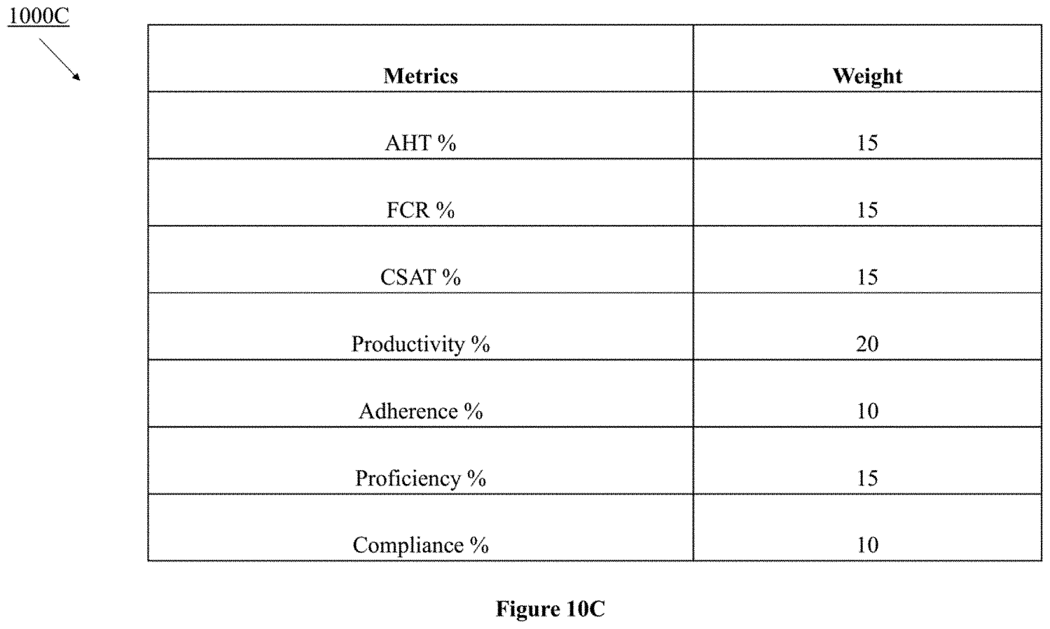

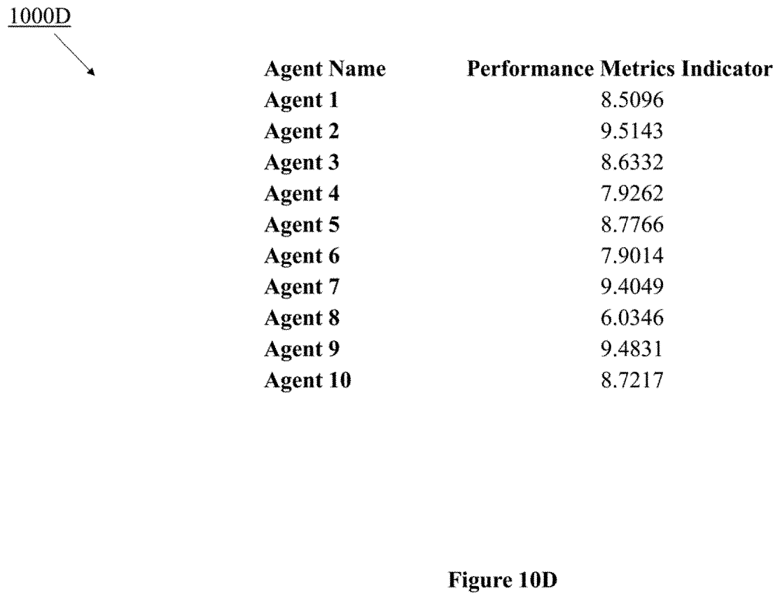

According to some embodiments of the present disclosure, system 300 includes the same components as system 100 in FIG. 1. One or more applications, such as in-house applications, e.g., WFM, RTAM and Nexidia 310 and such as third-party applications e.g., third-party CRM 310b may be integrated into the system 300. These applications may generate agent related data which contains day to day activities of an agents and agent-customer interactions related metric values, For example, (i) agent key preferences, as shown in FIG. 9A; (ii) adherence metric values, as shown in FIG. 9C; and (iii) performance metric values as shown in FIGS. 10A-10B.

According to some embodiments of the present disclosure, the generated data may be pushed on PM application data node in the form of raw structured data tiles. A module, such as AEI module 110 in FIG. 1 and such as AEI module 200 in FIGS. 2A-2B may operate the PM application 180 in FIG. 1 to retrieve data during a preconfigured period from one or more applications to derive agent's related data and exporting the agent's related data into data files.

According to some embodiments of the present disclosure, a module, such as data-ingest module 120 in FIG. 1 and such as 330a may store the agent's related data from the data files into a data store, such as data store of processing management 150 in FIG. 1, which may be a part of a database associated to PM application, such as PM database 380.

According to some embodiments of the present disclosure, a module, such as transform module 330b and such as transform module 130 in FIG. 1, may be operated to transform the agent's related data by creating relational entities and calculating metrics. The transformed data may be then processed by an analytic engine, such as analytics engine 330c and such as analytic engine 140, to create insights from the processed data.

According to some embodiments of the present disclosure, the analytics engine 330c derives values for parameters based on respective formula and associated configuration, i.e., one or more indicators 340, such as agent preference adherence, e.g., based on formula (I), performance matric e.g., based on formula (II), coaching need e.g., based on formula (III), coaching effectiveness e.g., based on formula (IV) and agent satisfaction e.g., based on formula (V).

According to some embodiments of the present disclosure, based on the one or more indicators an Agent Engagement Index (AEI) 350 may be calculated. Then a set of actions may be derives based on the AEI and the one or more indicators 360. For example, improved workforce management, targeted coaching plan, agent preference management and attrition management, as shown in FIGS. 5-8.

According to some embodiments of the present disclosure, the analyzed data and associated reports, insights and actions 370 then can be accessed from PM Web node 370 by end users. For example, upon user's request via a User Interface (UI) e.g., UI 185 in FIG. 1 that is associated with the PM application, such as PM application 180 in FIG. 1, displaying the one or more indicators and the AEI for each agent and the determined one or more actions for each agent.

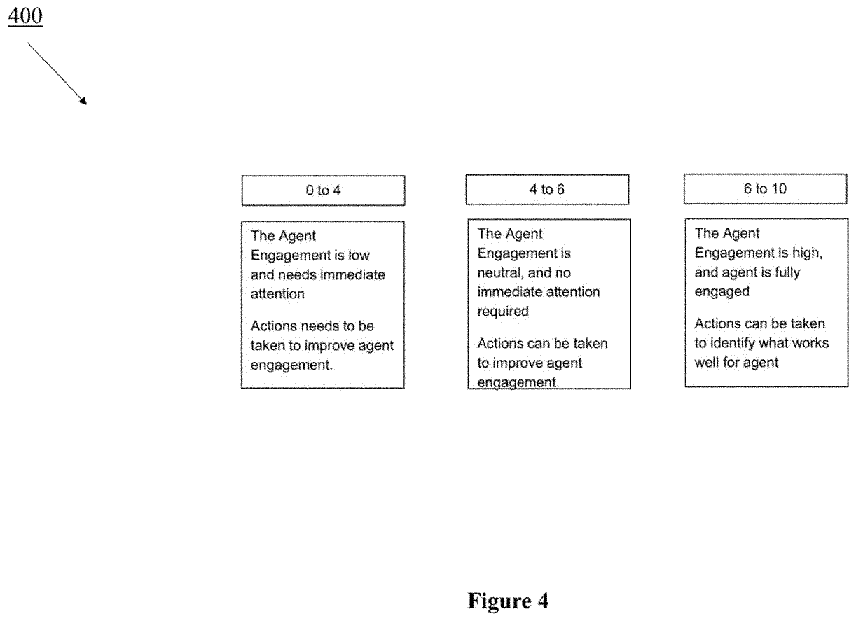

FIG. 4 illustrates an example 400 of an indication of Agent Engagement Index (AEI) ranges, in accordance with some embodiments of the present disclosure.

According to some embodiments of the present disclosure, when the AEI range is from ‘0’ to ‘4’ it may imply that the agent engagement is low and requires an immediate attention and actions needs to be taken to improve agent engagement.

According to some embodiments of the present disclosure, when the AEI range is from ‘4’ to ‘6’ it may imply that the agent engagement is neutral, and no immediate attention may be required. Actions can be taken to improve agent engagement.

According to some embodiments of the present disclosure, when the AEI range is from ‘6’ to ‘10’ it may imply that the agent engagement is high, and agent is fully engaged. Actions can be taken to identify what works well for the agent.

FIG. 5 is a high-level workflow of an agent preference management operation 500, in accordance with some embodiments of the present disclosure.

According to some embodiments of the present disclosure, the agent preference management may be operated by: for each agent preference adherence indicator 510 checking if the agent preference adherence indicator is lower than a first-preconfigured threshold 520. If the agent preference adherence indicator is lower than a first-preconfigured threshold, selecting ‘n’ preferences which are the highest based on their weightage from preferences that the adherence value is less than a second-preconfigured threshold 530. If the agent preference adherence indicator is not lower than the first-preconfigured threshold, selecting ‘n’ preferences which are the highest based on their weightage 540.

According to some embodiments of the present disclosure, sending the selected ‘n’ preferences to the PM application to be presented via the UI 550.

FIG. 6A-6B are a high-level workflow of a targeted coaching plan operation 600, in accordance with some embodiments of the present disclosure.

According to some embodiments of the present disclosure, coaching effectiveness indicator represents the coaching effectiveness derived from performance metrics change for considered duration after coaching was done for that agent.

According to some embodiments of the present disclosure, the targeted coaching plan may be operated by: for each agent coaching need indicator 610, checking if the coaching need indicator is greater than a first-preconfigured threshold 620a or if coaching has been done for the agent 620b and if coaching effectiveness is greater than or equal ‘0’ 620c or when coaching hasn't been done, then selecting from the calculated metrics of the agent which are below a second-preconfigured threshold 630 and then identifying from the selected calculated metrics of the given agent metrics against which coaching has been done to select metrics where the difference between metric before coaching and after coaching is greater than a third-preconfigured threshold 640.

According to some embodiments of the present disclosure, identifying from the selected calculated metrics of the given agent metrics against which coaching has not been done to select metrics which are below the third-preconfigured threshold 650 and selecting ‘n’ metrics from the identified metrics which are highest based on their associated weightage 660. Then, sending the selected ‘n’ metrics to a coaching management application to be presented via a UI associated therewith 670.

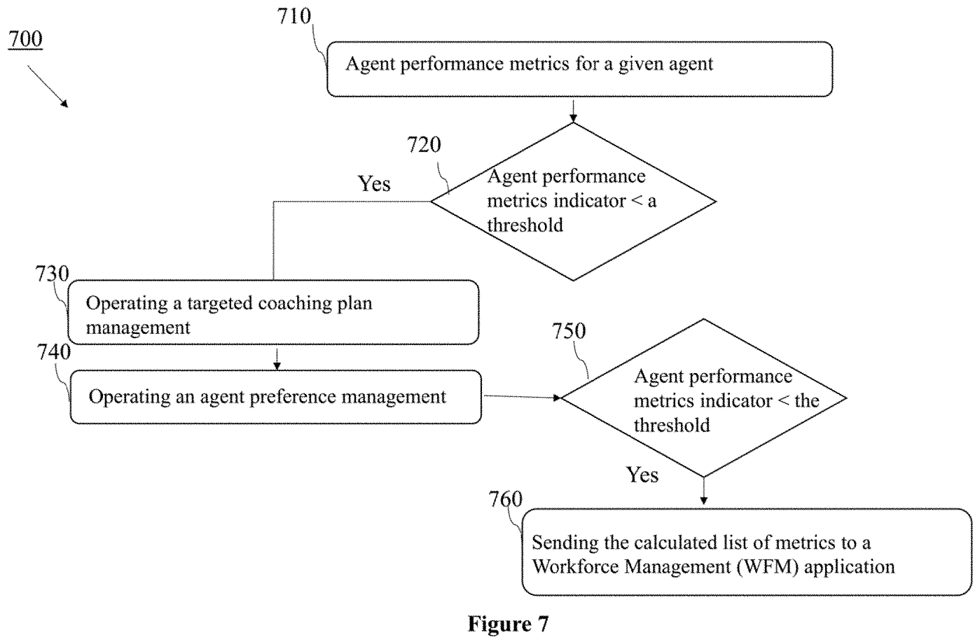

FIG. 7 is a high-level workflow of an improved workforce management operation 700, in accordance with some embodiments of the present disclosure.

According to some embodiments of the present disclosure, the improved workforce management may be operated for each agent performance metrics indicator 710, by checking if the agent performance metrics indicator is less than a preconfigured threshold 720 to operate: (i) a targeted coaching plan management 730; and (ii) an agent preference management 740; and then checking if the agent performance metrics indicator is less than the preconfigured threshold 750 to send the calculated list of metrics to a WFM application 760.

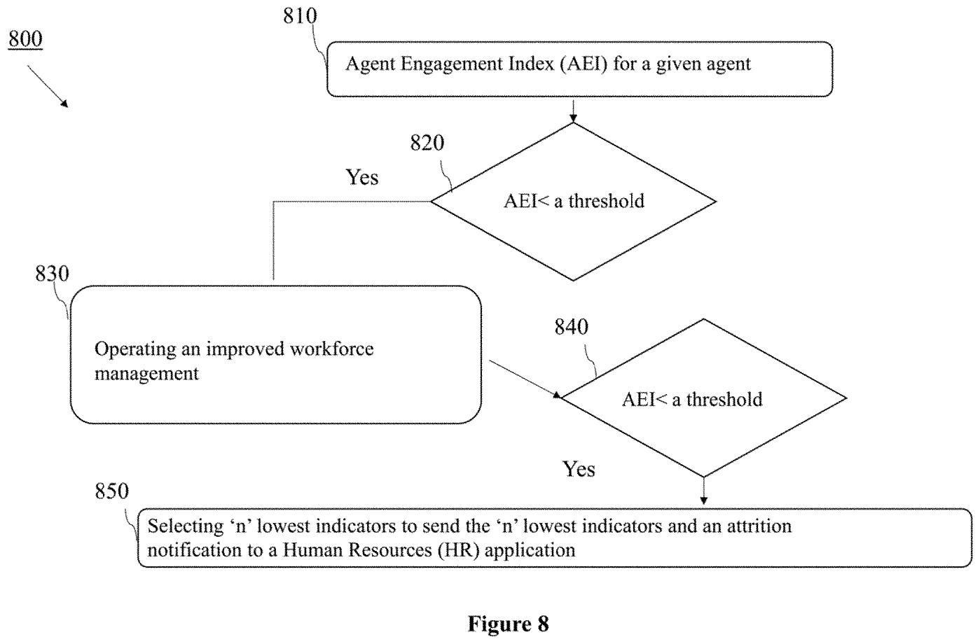

FIG. 8 is a high-level workflow of an attrition management operation 800, in accordance with some embodiments of the present disclosure.

According to some embodiments of the present disclosure, the attrition management may be operated for each AEI for a given agent 810 by checking if the AEI is less than a threshold 820 to operate an improved workforce management 830, as shown in FIG. 5, and then checking if the AEI is less than the threshold 840 to select ‘n’ lowest indicators and send the ‘n’ lowest indicators and an attrition notification to a Human Resources (FIR) application 850. The attrition notification may lead HR to take an appropriate action in order to prevent attrition.

According to some embodiments of the present disclosure, during a preconfigured period, which may be the duration of the assessment, e.g. the month of April or May, data has been retrieved from one or more applications to derive agent's related data and export the agent's related data into data files. A module, such as Agent Engagement Index (AEI) module 110 in FIG. 1, and such as AEI module 200 in FIGS. 2A-2B may operate a data-ingest module, such as data-digest module 120 to store the agent's related data from the data files into a data store, such as the data store of processing management 150. in FIG. 1. A module, such as transform module 130, in FIG. 1 may transform the agent's related data by creating relational entities and calculating the metrics.

According to some embodiments of the present disclosure, FIGS. 9A-9B, 10A-10C, 11A, 12A-12B, 13A and 14A-14B show data for calculations of indicators. The data includes a list of metrics which is for explanation purposes only and the size of the list and the metrics themselves may be preconfigured.

According to some embodiments of the present disclosure, the one or more indicators may be selected from at least two of: (i) agent preference adherence; (ii) performance metrics; (iii) coaching need; (iv) coaching effectiveness; and (v) agent satisfaction.

FIGS. 9A-9C are an example of a calculation of agent preference adherence indicator 900 given preferences and associated weights and preferences values received against each agent from the Performance Management (PM) application, in accordance with some embodiments of the present disclosure.

According to some embodiments of the present disclosure, agent preference adherence represents the agent preference adherence by the organization. The organization can meet agent's needs or preferences in terms of which shift agent prefers to work in, whether agent needs a mentor, choice to work-from-home, technologies, peer coaching, no enforcement of overtime, language and accent of choice. The more the organization acts to meet these needs or preferences, the more the agent engagement can be improved.

According to some embodiments of the present disclosure, the agent preference adherence indicator is calculated based on formula I:

[(Σᵢ₌₁ⁿ Weightageᵢ*Adherence_Valueᵢ)/((Σᵢ₌₁ⁿ Weightageᵢ)*10)]ₜ (I)

whereby:
i denotes a current iteration over a list of preferences,
n denotes a size of the list of preferences,
Weightageᵢ is a weightage associated with an i^{th} preference in the list of preferences,
Adherence_Valueᵢ is an adherence metric value for i^{th} preference, and
t is a duration of an assessment.

According to some embodiments of the present disclosure, the list of preferences may be for example such as the list in table 900A. The size of the list shown in table 900A is eight and the weightageᵢ is a weight associated with an i^{th} preference in the list of preferences.

According to some embodiments of the present disclosure, the adherence_valueᵢ is an adherence metric value for preference, as shown in table 900B for the duration of the assessment, e.g., a month.

According to some embodiments of the present disclosure, based on formula I and the values in tables 900A-900B the agent preference adherence for each agent may be calculated and is shown in table 900C.

FIGS. 10A-10D are an example of performance metrics calculation given two months of calculated metrics for agents and the associated weight for each performance metric, in accordance with some embodiments of the present disclosure.

According to some embodiments of the present disclosure, performance metrics indicator represents the aggregated values for key performance metrics denoting agent performance for a considered duration and associated weights for each performance metric set by organization.

According to some embodiments of the present disclosure, the performance metrics indicator is calculated based on formula II:

[(Σᵢ₌₁ⁿ Weightageᵢ*Metrics_Percentageᵢ)/((Σᵢ₌₁ⁿ Weightageᵢ)*10)]ₜ (II)

whereby:
i denotes a current iteration over a list of the calculated metrics,
n denotes a size of the list of the calculated metrics,
Weightageᵢ is a weightage associated with an i^{th} metric in the list of the calculated metrics,
Metrics_Percentageᵢ is a metric percentage value for the i^{th} metric, and
t is a duration of an assessment.

According to some embodiments of the present disclosure, table 1000A is a non-limiting example of a list of the calculated metrics, Average Handle Time (AUT), adherence, compliance, First Call Resolution (FCR), productivity, proficiency and Customer Satisfaction Score (CSAT) for ten agents for the duration of the assessment, e.g., the month of April. The list of metrics is for explanation purposes and the size of the list and metrics may be preconfigured.

According to some embodiments of the present disclosure, the performance metrics indicator, as shown in FIG. 10D for each agent may be calculated based on data from tables 1000B and table 1000C. Table 1000B shows a list of a size of seven metrics and the weightage associated with an i^{th} metric in the list of the calculated metrics, e.g., value of each metric for each agent of the ten agents. Table 1000C shows the metric percentage value for each metric.

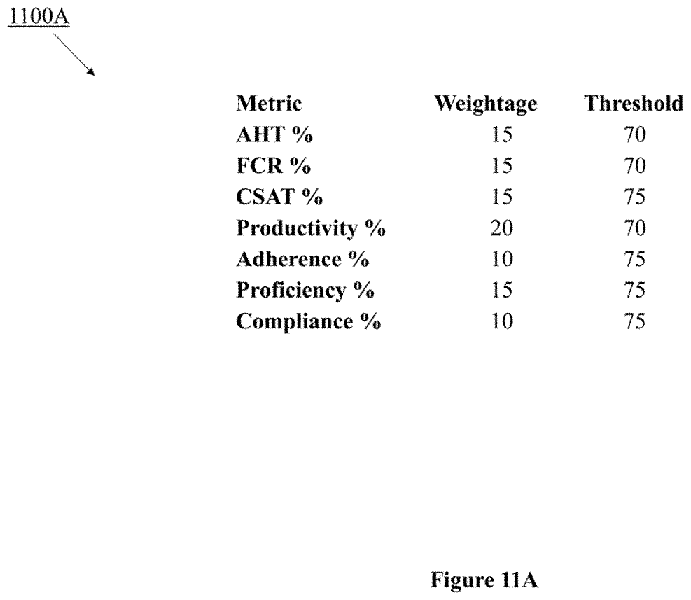

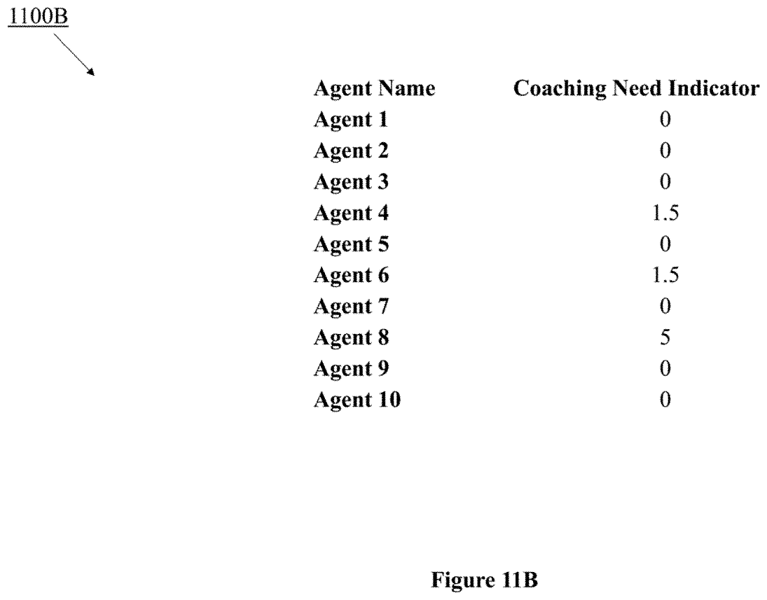

FIGS. 11A-11B are an example 1100 of a calculation of a coaching need indicator given the associated weight and threshold for each performance metric, in accordance with some embodiments of the present disclosure.

According to some embodiments of the present disclosure, the coaching need indicator may indicate a coaching need for an agent based on the agent performance metrics values for a considered duration, i.e., the duration of the assessment, e.g., a month.

According to some embodiments of the present disclosure, the coaching need indicator is calculated based on formula III:

[10−((Σᵢ₌₁ⁿ MetricWeightageᵢ*(MetricValueᵢ<X:1:0))/10)]ₜ (III)

whereby:
i denotes current iteration over a list of the calculated metrics,
n denotes a size of the list of the calculates metrics,
MetricWeightageᵢ is a weightage associated with an i^{th} metric,
MetricValueᵢ is a metric percentage value for the i^{th} metric,
X is a threshold value to identify a low performance,
(MetricValueᵢ<X:1:0) is if (MetricValue<X) is true then 1 else 0, and
t is a duration of an assessment.

According to some embodiments of the present disclosure, the list of the calculated metrics may be for example as shown in table 1100A along with each metric associated weightage and ‘X’ threshold value.

According to some embodiments of the present disclosure, the coaching need indicator may be calculated based on the list of calculated metrics as shown in table 1100A for the duration of the assessment, e.g., a month.

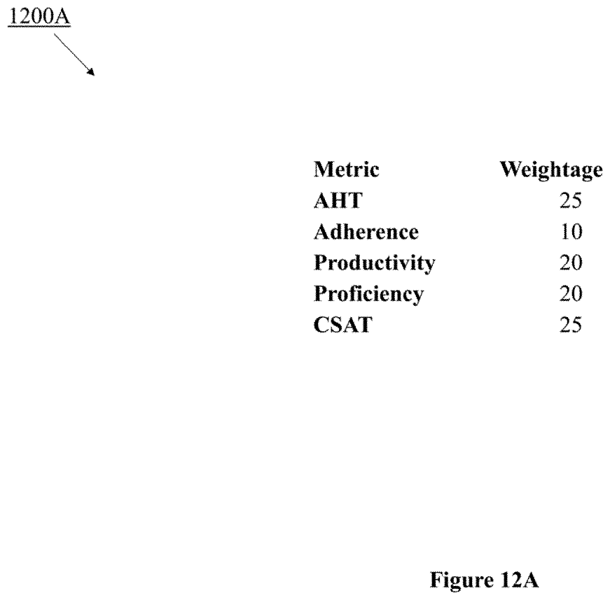

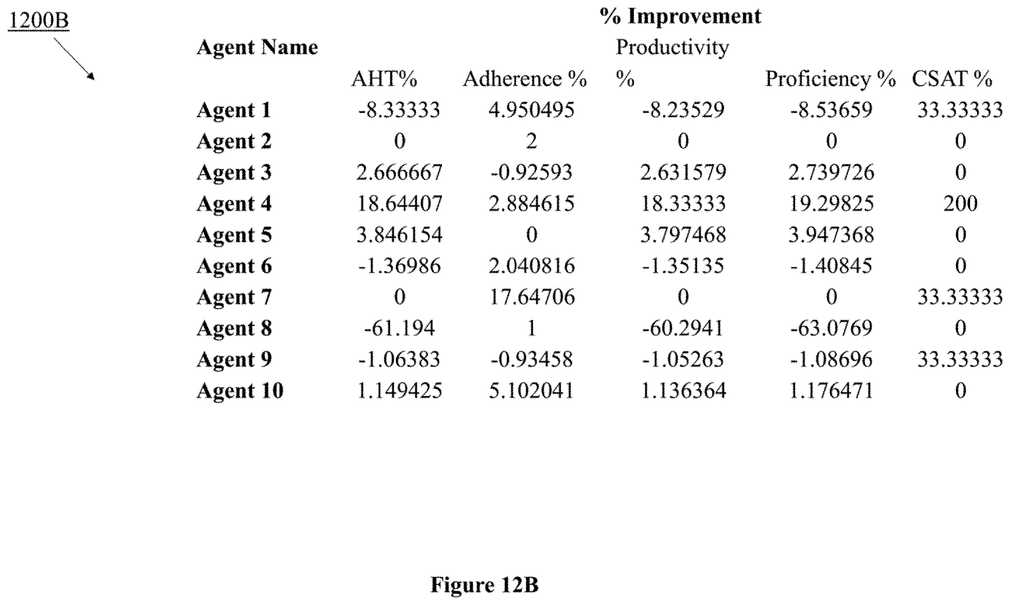

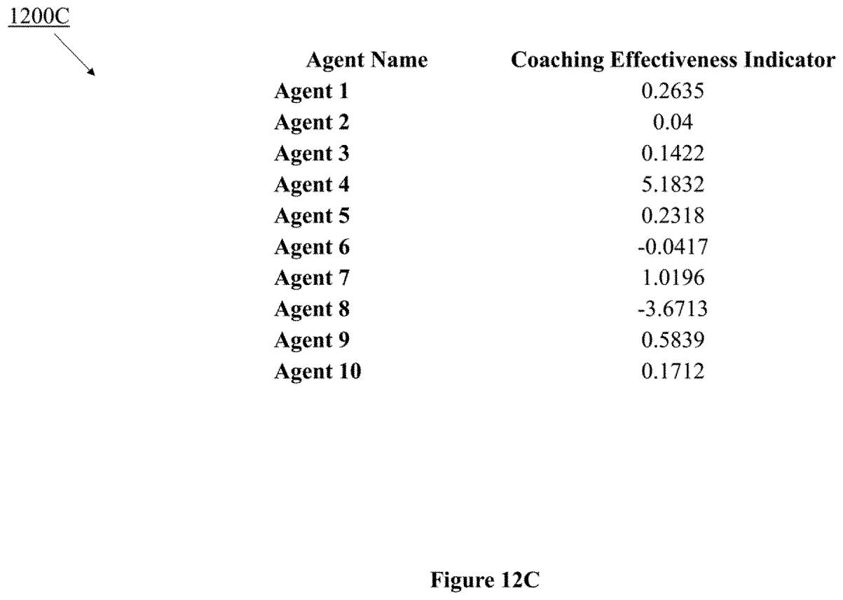

FIG. 12A-12C are an example of a calculation of a coaching effective indicator given the associated weight for each performance metric and the improvement percentage for each performance metric for each agent, in accordance with some embodiments of the present disclosure.

According to some embodiments of the present disclosure, the coaching effectiveness indicator may be calculated based on formula IV:

[(Σᵢ₌₁ⁿ % Improvement in Coaching Metricsᵢ)/(n*10)]ₜ (IV)

whereby:
i denotes a current iteration over the list of the calculated metrics,
n denotes a size of the list of the calculated metrics,
% Improvement in Coaching Metricsᵢ is an improvement seen after coaching was done, and
t is a duration of an assessment.

According to some embodiments of the present disclosure, table 1200A shows a weightage associated for each metric which is taken into consideration in formula II which calculates a performance metrics indicator. The list of the calculated metrics to be considered may be configurable and the metrics shown in table 1200A are for the purpose of explanations only.

According to some embodiments of the present disclosure, the performance improvement in percentage for example, as shown in table 1200B is calculated for selected metrics based on input data received for an earlier month, e.g., the month of April, as shown in table 1000A and a following month, e.g., the month of May, as shown in table 1000B.

According to some embodiments of the present disclosure, table 1200C shows a calculated coaching effective indicator for each agent for a duration of an assessment, e.g., a month, based on formula (IV) with % improvement in coaching metricsᵢ, as shown, for example, in table 1200B. The assessment is operated twice to measure an effective improvement before and after coaching was done.

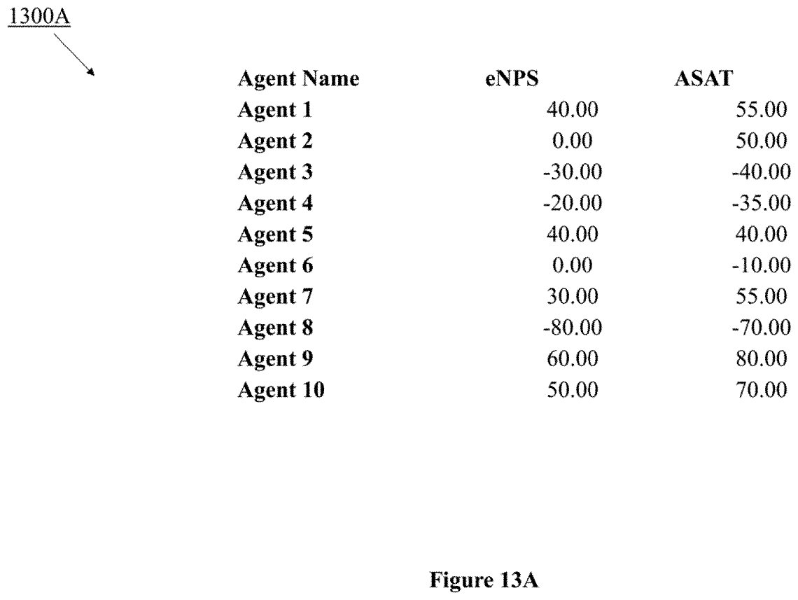

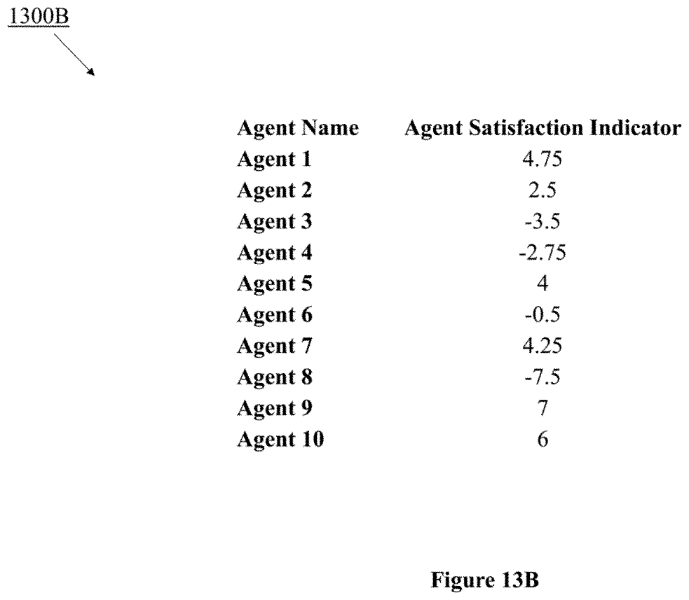

FIG. 13A-13B are an example of a calculation of agent satisfaction indicator over a given list of measures, in accordance with some embodiments of the present disclosure.

According to some embodiments of the present disclosure, agent satisfaction indicator represents aggregated value for agent satisfaction score based on survey-based measures.

According to some embodiments of the present disclosure, the agent satisfaction indicator may be calculated based on formula V:

[(Σᵢ₌₁ⁿ MeasureScoreᵢ)/(n*10)]ₜ (V)

whereby:
i denotes current iteration over a list of measures,
n denotes a size of the list of measures,
MeasureScoreᵢ is a score value of an i^{th} measure, and
t is a duration of an assessment.

According to some embodiments of the present disclosure, the list of measures may be for example ASAT, eNPS. eNPS is ‘employee Net Promoter Score’ and ASAT is ‘Agent Satisfaction’ score. A survey-based input data such as in table 1300A may be used to measure agents satisfaction for the duration of assessment. These surveys are commonly captured by the organization through agent surveys.

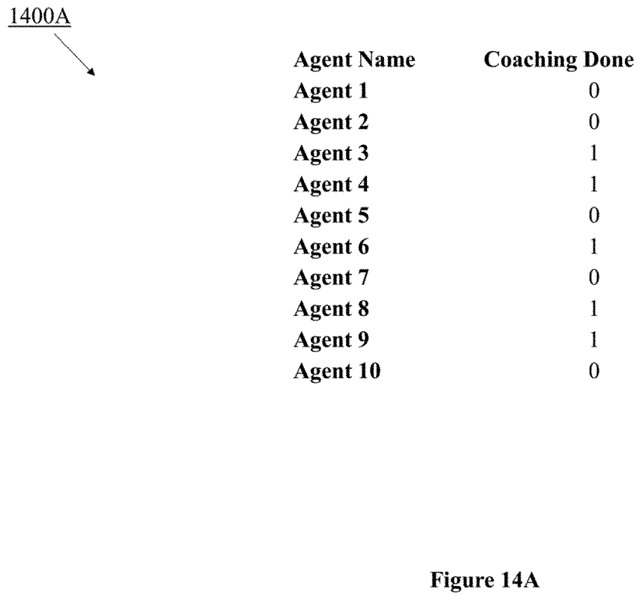

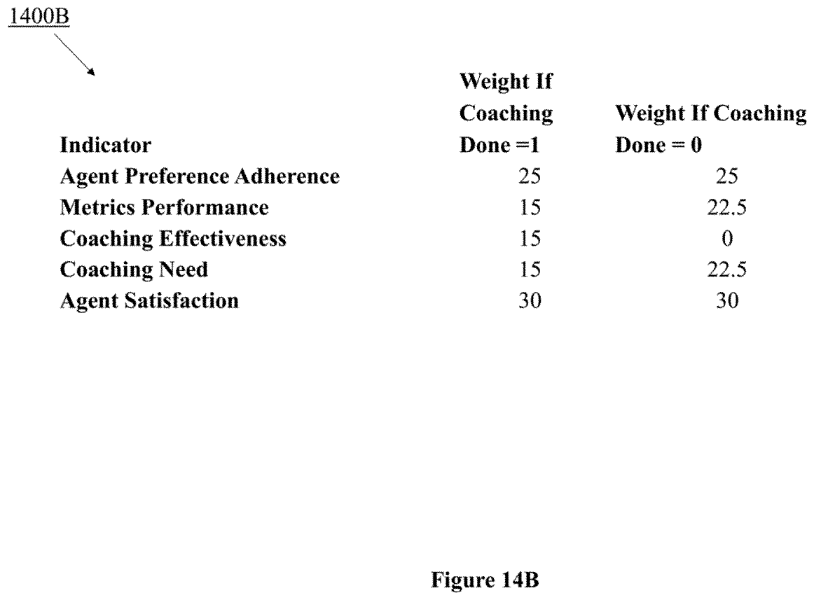

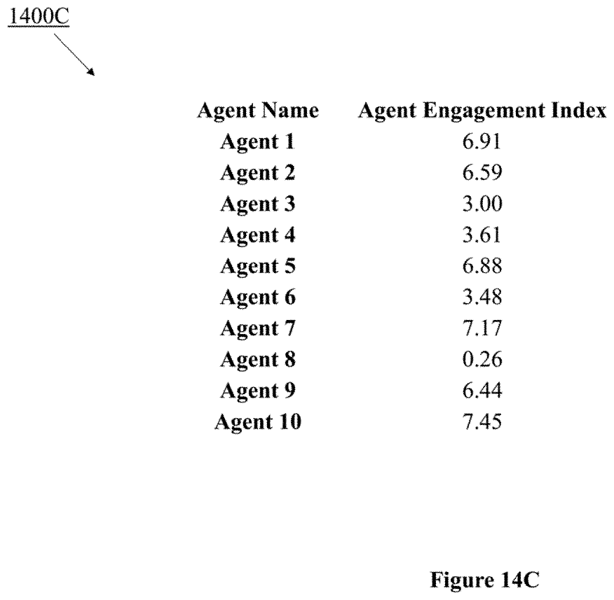

FIGS. 14A-14C are an example of a calculation of Agent Engagement Index (AEI), in accordance with some embodiments of the present disclosure.

According to some embodiments of the present disclosure, the AEI may be calculated based on formula VI:

$$If {( Coaching Done ) [ \frac{{\sum }_{i = 1}^{n} ( Weightage\_Coaching {\_done}_{i} * {indexValue}_{i} )}{{\sum }_{i = 1}^{5} Weightage\_Coaching {\_done}_{i}} ]}_{t} \qquad ( VI )$$

$${Else [ \frac{{\sum }_{i = 1}^{n} ( Weightage\_Coaching \_not {\_done}_{i} * {indexValue}_{i} )}{{\sum }_{i = 1}^{5} Weightage\_Coaching \_not {\_done}_{i}} ]}_{t}$$

whereby:
‘Coaching Done’ is a binary indicator for an executed coaching where ‘1’—indicates that coaching has been done and ‘0’ indicates that coaching has not been done,
n is a number of indicators,
i denotes a current iteration over the indicators,
Weightage_Coaching_doneᵢ is a weightage associated with an i^{th} indicator when coaching was executed for the agent,
indexValueᵢ is a calculated indicator value for the i^{th} indicator,
Weightage_Coaching_not_doneᵢ is a weightage associated with an i^{th} indicator when coaching was executed for the agent, and
t is a duration of an assessment.

According to some embodiments of the present disclosure, table 1400A shows for each agent if coaching has been done. ‘0’ indicates that coaching has not been done and ‘1’ indicates that coaching has been done. Table 1400B shows an example of a weight that is associated with each indicator when all five indicators are considered. (i) agent preference adherence; (ii) performance metrics; (iii) coaching need; (iv) coaching effectiveness; and (v) agent satisfaction.

According to some embodiments of the present disclosure, based on ‘Coaching Done’, the AEI calculation considers the coaching effectiveness indicator only if coaching has been done in considered duration for a respective agent. Formula VI has two parts, the first part takes coaching effectiveness into account and the second part does not take it into account.

According to some embodiments of the present disclosure, table 1400C shows the results of a calculation of AEI for each agent based on the data in tables 1400A-1400B and formula (VI). The AEI has been calculated based on five indicators for the purpose of explanation only and it may be calculated for at least two indicators according to the configuration.

According to some embodiments of the present disclosure, ‘’ agent 8 in table 1400C has the lowest AEI value, which means that the agent needs an immediate attention from the organization as shown in FIG. 4 and explained in the related paragraphs. ‘Agent 10’ has the highest AEI value which means that the agent is satisfied and engaged.

FIGS. 15A-15D are illustration examples of User Interface (UI) of agents engagement reports and actions, in accordance with some embodiments of the present disclosure.

According to some embodiments of the present disclosure, the AEI value for each agent may be displayed for a user on a dashboard that is associated to an application. For example, upon user's request via a User Interface (UI) that is associated with the PM application the one or more indicators and the AEI for each agent and the determined one or more actions for each agent may be displayed.

According to some embodiments of the present disclosure, the determined one or more actions for each agent may be selected from at least one of: (a) targeted coaching plan; (b) agent preference management (c) attrition management; and (d) improved workforce management.

According to some embodiments of the present disclosure, the operation of each determined action may be as shown in FIGS. 5-8 and explained in the related paragraphs.

According to some embodiments of the present disclosure, UI 1500A and UI 1500B illustrates examples of reports that may provide an insight to a user, such as a supervisor based on color-coded values e.g., 1510 and a drill down view to act upon e.g., 1520.

According to some embodiments of the present disclosure, the color-coded insights into the AEI values 1510 in UI 1500A may be based on a categorization of the AEI values as shown in FIG. 4.

According to some embodiments of the present disclosure, UI 1500B is an example of element 1530 which may provide insights into values of one or more indicators that were used to calculate AEI. Element 1540 in UI 1500B is another way to visually present the indicators that were used to calculate AEI and AEI for each agent.

According to some embodiments of the present disclosure, a user may be enabled to focus on areas of improvement and execute the determined one or more actions such as (a) targeted coaching plan; (b) agent preference management (c) attrition management; and (d) improved workforce management which were described in FIGS. 5-8 and the related paragraphs, for each agent via UI 1500C and UI 1500D.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for measuring an Agent Engagement Index (AEI) and associating actions to improve thereof, said computerized-method comprising:
in a system comprising one or more processors, a data store of agents and a data store of processing management; a memory to store the data stores, and a Performance Management (PM) application, said one or more processors are operating an Agent Engagement Index (AEI) module for an assessment of each agent in the data store of agents, said AEI module comprising:
operating the PM application to retrieve data during a preconfigured period from one or more applications to derive agent's related data and exporting the agent's related data into data files;
operating a data-ingest module to store the agent's related data from the data files into the data store of processing management;
operating a transform module to transform the agent's related data by creating relational entities and calculating metrics;
operating an analytic engine to process the relational entities and the calculated metrics for calculating one or more indicators and an AEI based thereon to be stored in the data store of agents;
determining one or more actions to improve the AEI based on the calculated AEI and the one or more indicators;
storing the determined one or more actions in the data store of agents to improve the AEI and the one or more indicators; and
upon user's request via a User Interface (UI) that is associated with the PM application displaying the one or more indicators and the AEI for each agent and the determined one or more actions for each agent.

2. The computerized-method of claim 1, wherein the one or more applications are in-house applications or third-party applications which are integrated into the system.

3. The computerized-method of claim 1, wherein the one or more indicators are selected from at least two of: (i) agent preference adherence; (ii) performance metrics; (iii) coaching need; (iv) coaching effectiveness; and (v) agent satisfaction.

4. The computerized-method of claim 3, wherein the agent preference adherence indicator is calculated based on formula I:
[(Σᵢ₌₁ⁿ Weightageᵢ*Adherence_Valueᵢ)/((Σᵢ₌₁ⁿ Weightageᵢ)*10)]ₜ (II)
whereby:
i denotes a current iteration over a list of preferences,
n denotes a size of the list of preferences,
Weightageᵢ is a weightage associated with an i^{th} preference in the list of preferences,
Adherence_Valueᵢ is an adherence metric value for i^{th} preference, and
t is a duration of an assessment.

5. The computerized-method of claim 3, wherein the performance metrics indicator is calculated based on formula II:
[(Σᵢ₌₁ⁿ Weightageᵢ*Metrics_Percentageᵢ)/((Σᵢ₌₁ⁿ Weightageᵢ)*10)]ₜ (II)
whereby:
i denotes a current iteration over a list of the calculated metrics,
n denotes a size of the list of the calculated metrics,
Weightageᵢ is a weightage associated with an i^{th} metric in the list of the calculated metrics,
Metrics_Percentageᵢ is a metric percentage value for the i^{th} metric,
and
t is a duration of an assessment.

6. The computerized-method of claim 3, wherein the coaching need indicator is calculated based on formula III:
[10−((Σᵢ₌₁ⁿ MetricWeightageᵢ*(MetricValueᵢ<X:1:0))/10)]ₜ (III)
whereby:
i denotes current iteration over a list of the calculated metrics,
n denotes a size of the list of the calculates metrics,
MetricWeightageᵢ is a weightage associated with an i^{th} metric,
MetricValueᵢ is a metric percentage value for the i^{th} metric,
X is a threshold value to identify a low performance,
(MetricValueᵢ<X:1:0) is if (MetricValue<X) is true then 1 else 0, and
t is a duration of an assessment.

7. The computerized-method of claim 3, wherein the coaching effectiveness indicator is calculated based on formula IV:
[(Σᵢ₌₁ⁿ % Improvement in Coaching Metricsᵢ)/(n*10)]ₜ (IV)
whereby:
i denotes a current iteration over the list of the calculated metrics,
n denotes a size of the list of the calculated metrics,
% Improvement in Coaching Metricsᵢ is an improvement seen after coaching was done, and
t is a duration of an assessment.

8. The computerized-method of claim 3, wherein the agent satisfaction indicator is calculated based on formula V:
[(Σᵢ₌₁ⁿ MeasureScoreᵢ)/(n*10)]ₜ (V)
whereby:
i denotes current iteration over a list of measures,
n denotes a size of the list of measures,
MeasureScoreᵢ is a score value of an i^{th} measure, and
t is a duration of an assessment.

9. The computerized-method of claim 1, wherein the AEI is calculated based on formula VI:
$$If {( Coaching Done ) [ \frac{{\sum }_{i = 1}^{n} ( Weightage\_Coaching {\_done}_{i} * {indexValue}_{i} )}{{\sum }_{i = 1}^{5} Weightage\_Coaching {\_done}_{i}} ]}_{t} \qquad ( VI )$$
$${Else [ \frac{{\sum }_{i = 1}^{n} ( Weightage\_Coaching \_not {\_done}_{i} * {indexValue}_{i} )}{{\sum }_{i = 1}^{5} Weightage\_Coaching \_not {\_done}_{i}} ]}_{t}$$
whereby:
‘Coaching Done’ is a binary indicator for an executed coaching where ‘1’—indicates that coaching has been done and ‘0’ indicates that coaching has not been done,
n is a number of indicators,
i denotes a current iteration over the indicators,
Weightage_Coaching_doneᵢ is a weightage associated with an i^{th} indicator when coaching was done for the agent,
indexValueᵢ is a calculated indicator value for the i^{th} indicator,
Weightage_Coaching_not_doneᵢ is a is a weightage associated with an i^{th} indicator when coaching was not done for the agent, and
t is a duration of an assessment.

10. The computerized-method of claim 1, wherein the determined one or more actions are selected from at least one of: (a) targeted coaching plan; (b) agent preference management (c) attrition management; and (d) improved workforce management.

11. The computerized-method of claim 1, wherein said agent's related data includes at least one of: (i) agent key preferences; (ii) adherence metric values; and (iii) performance metric values.

12. The computerized-method of claim 10, wherein the agent preference management is operated by: for each agent preference adherence indicator when the agent preference adherence indicator is lower than a first-preconfigured threshold selecting ‘n’ preferences which are the highest based on their weightage from preferences that the adherence value is less than a second-preconfigured threshold and when the agent preference adherence indicator is higher than the first-preconfigured threshold selecting ‘n’ preferences which are the highest based on their weightage.

13. The computerized-method of claim 12, wherein sending the selected ‘n’ preferences to the PM application to be presented via the UI.

14. The computerized-method of claim 10, wherein the targeted coaching plan is operated by: for each agent coaching need indicator, when the coaching need indicator is greater than a first-preconfigured threshold or when coaching has been done for the agent and coaching effectiveness is greater than or equal ‘0’ or when coaching hasn't been done, selecting from the calculated metrics of the agent which are below a second-preconfigured threshold;
identifying from the selected calculated metrics of the given agent metrics against which coaching has been done to select metrics where the difference between metric before coaching and after coaching is greater than a third-preconfigured threshold;
identifying from the selected calculated metrics of the given agent metrics against which coaching has not been done to select metrics which are below the threshold;
selecting ‘n’ metrics from the identified metrics which are highest based on their associated weightage;
sending the selected ‘n’ metrics to a coaching management application to be presented via a UI associated therewith.

15. The computerized-method of claim 10, wherein the improved workforce management is operated for each agent performance metrics indicator, by checking if the agent performance metrics indicator is less than a preconfigured threshold to operate: (i) a targeted coaching plan management; and (ii) an agent preference management; and then checking if the agent performance metrics indicator is less than the preconfigured threshold to send the calculated list of metrics to a Workforce Management (WFM) application.

16. The computerized-method of claim 10, wherein the attrition management is operated for each AEI by checking if the AEI is less than a threshold to operate an improved workforce management, and then checking if the AEI is less than the threshold to select ‘n’ lowest indicators; and sending the ‘n’ lowest indicators and an attrition notification to a Human Resources (HR) application.

17. A computerized-system for measuring an Agent Engagement Index (AEI) and associating actions to improve thereof, said computerized-system comprising:
one or more processors;
a data store of agents and a data store of processing management;
a memory to store the data store; and
a Performance Management (PM) application,
said one or more processors are operating an Agent Engagement Index (AEl) module for an assessment of each agent in the data store of agents, said AEI module is configured to:
operate the PM application to retrieve data from one or more applications to derive agent's related data and export the agent's related data into data files;
operate a data-ingest module to store the agent's related data from the data files into the data store of processing management;
operate a transform module to transform the agent's related data by creating relational entities and calculating metrics;
operate an analytic engine to process the relational entities and the calculated metrics for calculating one or more indicators and an AEI based thereon;
determine one or more actions to improve the AEI based on the calculated AEI and the one or more indicators;
store the determined one or more actions to improve the AEI, the AEI and the one or more indicators; and
upon user's request via a User Interface (UI) that is associated with the PM application display the one or more indicators and the AEI for each agent and the determined one or more actions, for each agent.
